(19) United States
(12) Patent Application Publication
(10) Pub. No.: US 2010/0295222 A1
(43) Pub. Date: Nov. 25, 2010

(54) ACTUATOR AND SPRING USED THEREFOR

(76) Inventors: Sang Ho Lee, Daegu (KR); Byung Han Kim, Gyeongsangbuk-do (KR)

Correspondence Address: MCDERMOTT WILL & EMERY LLP, 600 13TH STREET, N.W., WASHINGTON, DC, 20005-3096, US

(21) Appl. No.: 12/668,376

(22) PCT Filed: Jul. 8, 2008
(86) PCT No.: PCT/KR2008/004006

§ 371 Date: Jul. 12, 2010

(30) Foreign Application Priority Data
Jul. 9, 2007 (KR) 10-2007-0068587
Jul. 9, 2007 (KR) 10-2007-0068588
Dec. 20, 2007 (KR) 10-2007-0134164

(51) Int. Cl. F16F 1/10; F16F 1/12; F16F 1/06; F16F 3/04

(52) U.S. Cl. 267/155; 267/154; 267/169

(57) ABSTRACT

Disclosed are an actuator capable of preventing interference caused by torsion to thereby improve stability and reliability, and a spring used for the actuator. The actuator includes a first molding part, a second molding part being rotatably connected in an end of the first molding part, and a spring member including a first spring arm that is fixed to the first molding part and a second spring arm that is fixed to the second molding part. In this instance, the first spring and the second spring arms are integrally connected to each other.

### TECHNICAL FIELD

The present invention relates to an actuator and a spring used for the actuator, and more particularly, to an actuator capable of preventing interference caused by torsion to thereby improve stability and reliability, and a spring used for the actuator.

### BACKGROUND ART

A slide-type mobile phone may use an actuator of providing elasticity. The actuator may provide a driving force so that a body portion and a sliding portion may semi-automatically or automatically operate. A general actuator is a torsion spring including a coil elastic portion. Therefore, both ends of the torsion spring are installed in a slide hinge or body to thereby provide the force for the sliding movement.

The conventional spring includes a coil elastic portion and a wiring portion that is extended from the coil elastic portion. The coil elastic portion is curved into a spiral type on the same plane. However, there is a disadvantage in that the conventional spring cannot be operated with maintaining one structural plane. For example, it may be desirable that the coil elastic portion and the wiring portion of the spring move on the same plane at all times. However, when torsion occurs, the coil elastic portion and the wiring portion may not maintain balance on one plane and thus may be upwardly and downwardly protruded, causing unnecessary friction with another structure of the slide hinge or the body.

The protruded spring may cause friction with an adjacent structure to thereby generate dusts. When it gets serious, the spring may be stuck into the adjacent structure to thereby prevent a slide opening/closing process of a mobile terminal. In particular, when increasing a number of windings of the coil elastic portion or decreasing a winding diameter, it may increase a protrusion probability of the spring and the effect by flow of the spring.

### DISCLOSURE

### Technical Problem

An aspect of the present invention provides an actuator that may improve stability and reliability, and a spring used for the actuator.

Another aspect of the present invention also provides an actuator that may minimize flow of a spring when operating the spring and prevent interference caused by flow of the spring, and a spring used for the actuator.

Another aspect of the present invention also provides an actuator that can minimize a space required for installation and operation of a product and improve a space utilization and design freedom of an object to install the product, and a spring used for the actuator.

### Technical Solution

According to an aspect of the present invention, there is provided an actuator including: a first molding part; a second molding part being rotatably connected in an end of the first molding part; and a spring member comprising a first spring arm that is fixed to the first molding part and a second spring arm that is fixed to the second molding part, wherein the first spring arm and the second spring arm are integrally connected to each other.

The first molding part may be directly rotatably coupled with the second molding part. Depending on embodiments, the first molding part and the second molding part may be indirectly coupled with each other via a coupling member such as bussing, a pin, and the like. For example, a round portion may be formed in the end of the first molding part, and a rotation guide surface may be formed on the second molding part to guide the rotation of the round portion. The first molding part may be rotatably coupled with the second molding part via the round portion and the rotation guide surface.

It may be desirable that the first molding part and the second molding part are constructed to rotate on one plane with maintaining a mutual parallel state. Depending on embodiments, the first molding part and the second molding part may be constructed to rotate on different surfaces in a tilted state with respect to each other.

A combining protrusion may be formed in one side of the second molding part to restrain separation of the first molding part. A number of protrusions and an displacement structure thereof may be variously modified according to a required condition and a design specification. Also, the combining protrusion may be formed in each of the first and the second molding parts.

A first receiving groove may be formed in the first molding part to receive at least one portion of the first spring arm, and a second receiving groove may be formed in the second molding part to receive at least one portion of the second spring arm. The first and the second spring arms may be fixed to the first molding part and the second molding part in such a manner that the first and the second spring arms are received in the first and the second receiving grooves, respectively.

In this instance, the first receiving groove and the second receiving groove may include an opening in the facing direction, or may have the opening in the same direction.

A scheme of fixing each spring arm in each corresponding molding part may be variously modified according to the required condition and the design specification. For example, each spring arm may be fixed in each corresponding receiving groove using a snap-fit combining scheme. For this, each of the first and the second molding parts may further include a snap-fit coupling portion that is formed to snap-fit couple each spring arm in each corresponding receiving groove. According to embodiments, it is possible to exclude the snap-fit coupling portion and directly fix the first and the second spring arms in the first and the second receiving grooves using an interference fit scheme.

Each of the first and the second molding parts may further include a pivot coupling portion that is pivot coupled with an object. In order to simplify a structure and a manufacturing process, it may be desirable that the pivot coupling portion is formed together when the first molding part and the second molding part are formed by molding injection. Also, the pivot coupling portion may be separately provided to each of the first and the second molding parts.

The spring member may further include a coil elastic portion that is integrally connected between the first spring arm and the second spring arm. The structure and the shape of the coil elastic portion may be variously modified according to the required condition and the design specification. For example, the coil elastic portion may include: a first outer coil of which one end is connected to the first spring arm; an inner coil having a relatively smaller winding diameter than the first outer coil and of which one end is connected to another end of the first outer coil; and a second outer coil having a relatively larger winding diameter than the inner coil, and of which one end is connected to another end of the inner coil and the other end is connected to the second spring arm. The first and the second outer coils may be closely disposed, and the inner coil may be disposed inside the first and the second outer coils.

Desirably, the first and the second outer coils may be formed to have a corresponding winding diameter. Also, the first and the second outer coils may be formed to have different winding diameters.

Also, a number of windings for at least one of the first and the second outer coils, and the inner coil may be plural. However, the present invention is not limited thereto or restricted thereby.

Also, the first molding part may include a first receiving hole to receive the coil elastic portion, and the second molding part may include a second receiving hole to receive the coil elastic portion. In addition, the first and the second receiving holes may be formed to have a corresponding diameter and to be connected to each other.

When forming the receiving grooves, a suspend-inserting groove may be formed in each of the first and the second molding parts formed on its sides to be connected with each corresponding receiving groove.

According to another aspect of the present invention, there is provided an actuator including: a first molding part; a second molding part being rotatably connected in an end of the first molding part; a third molding part being rotatably connected in an end of the second molding part; a first torsion spring include a first spring arm fixed to each of the first and the second molding parts; and a second torsion spring include a second spring arm fixed to each of the second and the third molding parts.

The first torsion spring and the second torsion spring may be integrally connected to each other or may be separately provided according to the required condition and the design specification. For example, facing spring arms among a pair of spring arms constituting the first torsion spring and a pair of spring arms constituting the second torsion spring may be spaced apart from each other to thereby be separated from each other. Unlike this, the facing spring arms among the pair of spring arms constituting the first torsion spring and the pair of spring arms constituting the second torsion spring may be integrally connected to each other. In this instance, connecting the spring arms of the first and the second torsion springs may mean that the first and the second torsion springs may be provided in a single integrated spring structure by consecutively curving a single wire rod.

A rotation region of the first and the third molding parts may be variously changed according to the required condition and the design specification. For example, the first and the third molding parts may rotate in the same region based on a long axis of the second molding part. Specifically, the first and the third molding parts may rotate in one side region based on the long axis of the second molding part, for example, within 180 degrees based on the long axis of the second molding part. Also, the first and the third molding parts may be constructed to rotate in different regions based on the long axis of the second molding part. Specifically, the first and the third molding parts may be constructed to rotate in the different regions, respectively, based on the long axis of the second molding part.

According to still another aspect of the present invention, there is provided a first molding part; a second molding part being rotatably connected in an end of the first molding part; a third molding part being rotatably connected in an end of the second molding part, and a spring member being fixed to the molding parts. The spring member may include a first spring arm that is fixed to the first molding part, a second spring arm that is fixed to the second molding part, and a third spring arm that is fixed to the third molding part. The first to the third spring arms may be directly or indirectly connected to the first to the third molding parts to thereby elastically operate them, respectively. In this instance, the second spring arm being fixed to the second molding part may be understood that facing arms among spring arms of the first torsion spring and the second torsion spring are connected to each other.

Since the spring arms of the spring member are fixed to the molding parts, it is possible to minimize flow of the spring. Also, since the molding parts are coupled with each other to thereby rotate within a predetermined range, the actuator may travel a certain route without up/down flow. In order to fix each spring arm in its corresponding molding part, attaching or welding the spring arms on the molding parts may be considered. However, it may be desirable to form, in a molding part, a receiving groove capable of receiving a spring arm and then insert the spring arm into the receiving groove. In this instance, the molding part may be formed of plastic or metal, or desirably may be formed by molding injection.

For the smooth rotation of the molding part, a first round portion may be formed in at least one side of the first and the second molding parts, and a first guide surface for guiding rotation of the first round portion and a first combining protrusion for restraining separation of the first round portion may be formed in another side of the first and the second molding parts. Also, a second round portion may be formed in at least one side of the second and the third molding parts, and a second guide surface for guiding rotation of the second round portion and a second combining protrusion for restraining separation of the second round portion may be formed in another side f the second and the third molding parts. In this case, since the molding part is combined by the spring arm, the round portion and the rotation guide surface of the molding part may maintain a closely attached state without a separate combining device or structure.

Also, a receiving hole capable of receiving the coil elastic portion of the spring member may be formed in the first or the second round portion. Also, it is possible to use a spring member excluding the coil elastic portion or including the coil elastic portion in either side.

A slit may be formed in the second molding part, and coil portions of the first and the second torsion springs may be positioned in the opposite surface based on the second molding part, and the integrally connected spring arm of the first and the second torsion springs may pass through the slit. Also, the first and the second spring arms contacting with the first and the third molding parts in the first and the second torsion springs may respectively make contact with the first and the third molding parts in the opposite direction to the integrally connected spring arm contacting with the second molding part.

According to yet another aspect of the present invention, there is provided a spring including, a first spring arm, a second spring, and a third spring arm that are connected to each other, and a coil elastic portion being formed at least one of between the first and the second spring arms and between the third and the third spring arms. The coil elastic portion may include a first outer coil being connected to any one of the first to the third spring arms, an inner coil having a relatively smaller winding diameter than the first outer coil and of which one end is connected to the first outer coil, and a second outer coil having a relatively larger winding diameter than the inner coil, and of which one end is connected to another end of the inner coil and of which the other end is connected to another spring arm of the first and the third spring arms.

The spring may be used to fix the spring arm in the molding part, and may also be used alone. The coil elastic portion may secure a sufficient number of windings using the inner coil and the outer coil and may provide a sufficiently large force even in the case of the same winding diameter.

According to a further aspect of the present invention, there is provided an actuator of a slide-type mobile phone comprising a body that includes a keypad and a fixed frame and a cover that includes a sliding frame slidably coupled with the fixed frame to open and close the keypad and a display portion, the actuator including: a first link plate being installed in the sliding frame to be rotatable using a first pivot pin by providing a first shaft to be parallel between the fixed frame and the sliding frame; a second link plate being installed in the fixed frame to be rotatable using a second pivot pin by providing a second shaft to correspond to the first shaft; a connecting plate including first and second guide holes punctured in both sides to slidably guide the first and the second shafts; first and second compression coil springs being installed in the outer circumference of the first and the second shafts to close and open the keypad using the cover while the sliding frame is elastically sliding along the fixed frame by a certain external force; and a flow preventing unit preventing flow of the first and the second link plates that slide in both sides of the connecting plate.

In this instance, the flow preventing unit may include a first guide rail in the first link plate along the axial direction of the first shaft, and forms a first flow preventing groove in the connecting plate to prevent flow when it is slidably coupled along the first guide rail. Also, the flow preventing unit may include a second guide rail in the second link plate along the axial direction of the second shaft, and forms a second flow preventing groove in the connecting plate to prevent flow when it is slidably coupled along the second guide rail.

An actuator and a spring according to the present invention may be applicable to a general sliding module that slidably connects a body portion and a sliding portion in a general slide-type portable device, and may also be applicable to various types of devices and structures as well as the sliding module.

### Advantageous Effects

According to the present invention, each spring arm of a spring member (torsion spring) may be operated in a fixed state supported by each corresponding molding part. Therefore, it is possible to minimize flow of a spring when operating the spring, prevent interference caused by flow of the spring, and to improve the lifespan of the spring.

Also, according to the present invention, it is possible to provide elasticity of greater than or equal to a predetermined level without increasing the thickness of a spring member. Therefore, it is possible to contribute to the small size and slimness of an actuator and a product using the actuator.

Also, according to the present invention, there is no need for a separate riveting process for pivot coupling an actuator with an object, and when each molding part is formed by molding injection, a pivot coupling portion may be integrally formed with the molding part. Therefore, it is possible to simplify a structure and a manufacturing process and also contribute to costs reduction and production enhancement.

Also, in an actuator according to the present invention, since torsion springs are provided in parallel, it is possible to minimize the traffic line according to the elastic rotation of the torsion springs. Specifically, since a molding part including a torsion spring is formed to be nearly linear, the width of traffic line of the torsion spring may be minimized to thereby improve the utilization of regions excluding a region where the torsion spring and the molding part are provided.

Also, according to the present invention, since a compressed coil spring elastically operating along an axial direction is used, a sliding frame may slide not to cause friction on a fixed frame and the sliding frame. Therefore, it is possible to prevent noise and improve operational reliability.

Also, according to the present invention, it is possible to prevent left/right flow of first and second link plates that slide in both sides of a connecting plate and also induce a linear contact to thereby reduce friction. Therefore, noise occurrence may be significantly reduced.

Also, according to the present invention, first and second compression coil springs may be provided along outer circumference of first and second shafts to prevent flow and separation. Therefore, it is possible to slim the thickness of the first and the second link plates, and the connecting plate to be suitable for the outer circumference of the first and the second compression coil springs. Also, it is possible to reduce the thickness of a mobile phone consisting of a body and a cover.

### DESCRIPTION OF DRAWINGS

FIGS. 1 and 2 are perspective views illustrating the structure of an actuator according to an embodiment of the present invention;

FIG. 3 is an exploded-perspective view illustrating the structure of an actuator according to an embodiment of the present invention;

FIG. 4 is a top-plane view illustrating the structure of an actuator according to an embodiment of the present invention;

FIG. 5 is a rear view illustrating the structure of an actuator according to an embodiment of the present invention;

FIG. 6 is a cross-sectional view cut along a line II-II of FIG. 2;

FIG. 7 is a perspective view illustrating the structure of a spring according to an embodiment of the present invention;

FIG. 8 is a perspective view illustrating the structure of an actuator according to another embodiment of the present invention;

FIG. 9 is a top-plane view illustrating the structure of an actuator according to another embodiment of the present invention;

FIG. 10 is an exploded-perspective view for describing a portable device adopting an actuator according to an embodiment of the present invention;

FIG. 11 is a perspective view for describing the actuator shown in FIG. 10;

FIG. 12 is a top-plane view for describing the actuator shown in FIG. 11;

FIG. 13 is a rear view for describing the actuator shown in FIG. 11;

FIG. 14 is an exploded-perspective view of the actuator shown in FIG. 11;

FIG. 15 is a perspective view for describing a third molding part of the actuator shown in FIG. 11;

FIGS. 16 and 17 are top-plane views for describing the operation of the portable device and the actuator shown in FIG. 10;

FIG. 18 is a perspective view for describing an actuator according to another embodiment of the present invention;

FIG. 19 is a rear view for describing the actuator shown in FIG. 18;

FIG. 20 is a perspective view for describing a third molding part of the actuator shown in FIG. 18;

FIG. 21 is a perspective for describing a spring according to still another embodiment of the present invention;

FIG. 22 is a cross-sectional view cut along a line III-III for describing the spring shown in FIG. 21;

FIG. 23 is an exploded-perspective view illustrating a portable device adopting an actuator according to an embodiment of the present invention;

FIG. 24 is a perspective view illustrating an actuator according to an embodiment of the present invention;

FIG. 25 is an exploded-perspective view of the actuator shown in FIG. 24;

FIG. 26 is a perspective view illustrating the structure of an actuator according to another embodiment of the present invention;

FIG. 27 is an exploded-perspective view of the actuator shown in FIG. 26;

FIG. 28 is a perspective view illustrating a torsion spring of an actuator according to another embodiment of the present invention;

FIG. 29 is a perspective view illustrating a second molding part according to another embodiment of the present invention;

FIGS. 30 to 32 are top-plane views illustrating the operational structure of an actuator according to an embodiment of the present invention;

FIG. 33 is a front view illustrating an actuator of a slide-type mobile phone according to an embodiment of the present invention;

FIG. 34 is a perspective view illustrating a coupled state of a slide-type mobile phone and an actuator according to an embodiment of the present invention;

FIG. 35 is an exploded perspective view illustrating an actuator of a slide-type mobile phone according to an embodiment of the present invention;

FIG. 36 is a cross-sectional view cut along a line I-I of FIG. 34;

FIGS. 37 and 38 are partially enlarged views of a coupled state between first and second link plates and a connecting plate in an actuator of a slide-type mobile phone according to an embodiment of the present invention; and

FIGS. 39 to 41 are operational diagrams sequentially illustrating an operational state of an actuator of a slide-type mobile phone according to an embodiment of the present invention.

### BEST MODE

Reference will now be made in detail to embodiments of the present invention, examples of which are illustrated in the accompanying drawings, wherein like reference numerals refer to the like elements throughout. The embodiments are described below in order to explain the present invention by referring to the figures.

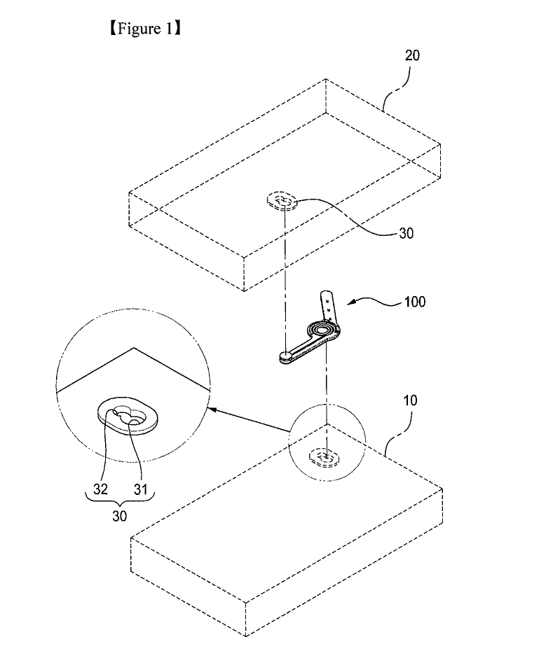

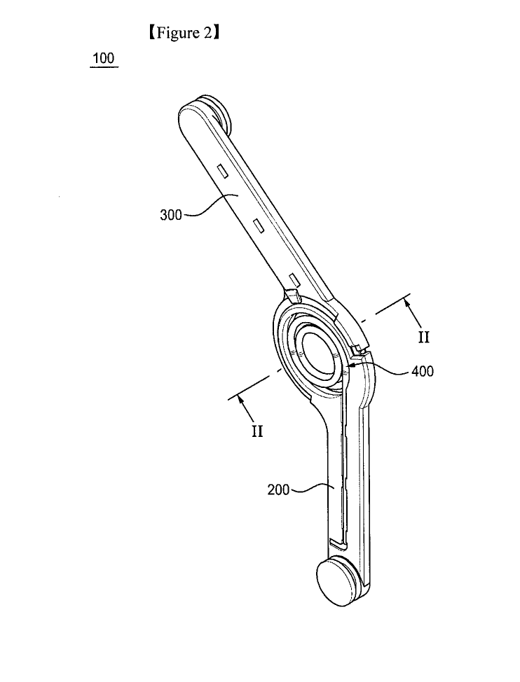

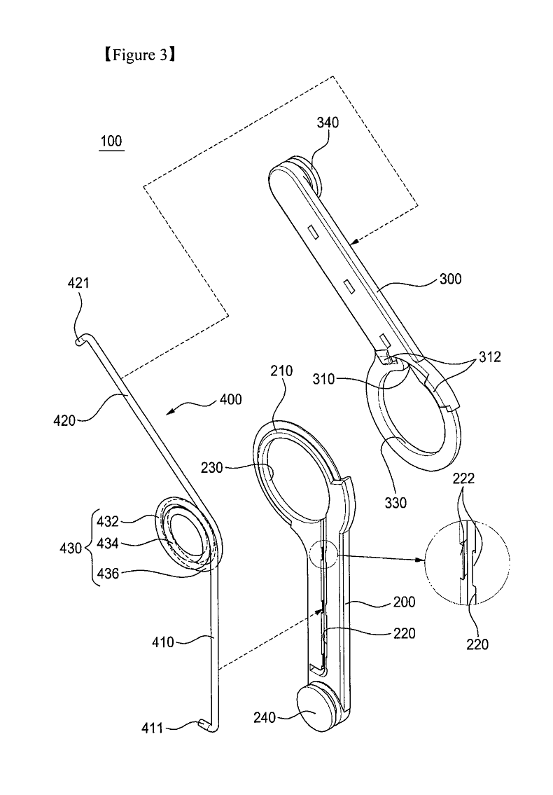

FIGS. 1 and 2 are perspective views illustrating the structure of an actuator according to an embodiment of the present invention, and FIG. 3 is an exploded-perspective view illustrating the structure of an actuator according to an embodiment of the present invention.

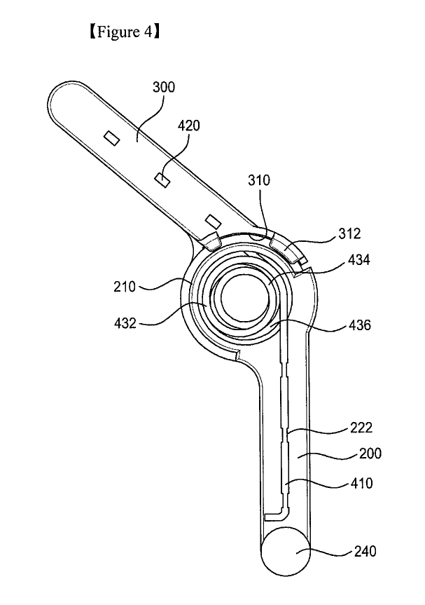

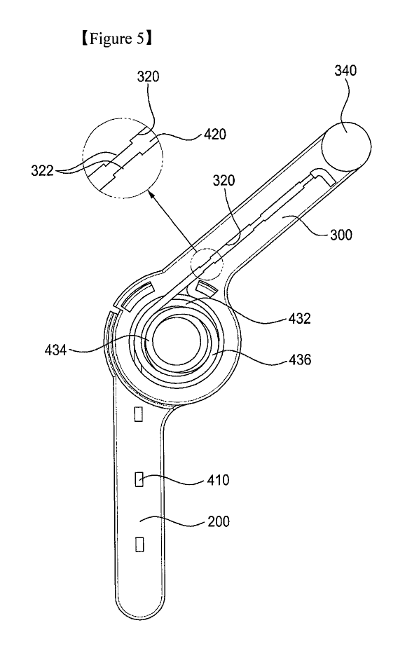

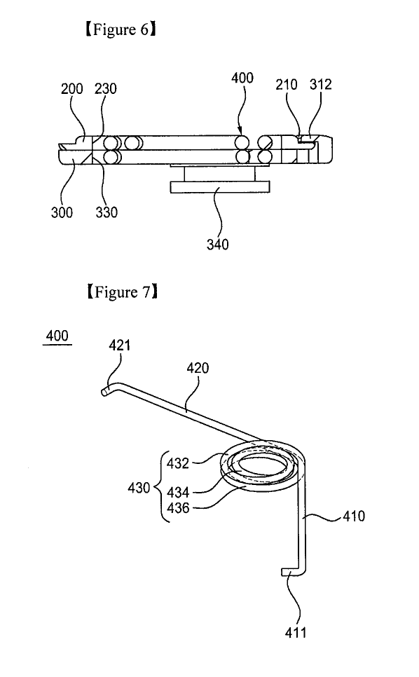

Also, FIG. 4 is a top-plane view illustrating the structure of an actuator according to an embodiment of the present invention, FIG. 5 is a rear view illustrating the structure of an actuator according to an embodiment of the present invention, and FIG. 6 is a cross-sectional view cut along a line II-II of FIG. 2. FIG. 7 is a perspective view illustrating the structure of a spring according to an embodiment of the present invention.

As shown in FIGS. 1 through 7, an actuator 100 according to an embodiment of the present invention includes a first molding part 200, a second molding part 300, and a spring member 400. The actuator 100 is disposed between mutually moving objects 10 and 20 to thereby enable the mutual elastic movement of the objects 10 and 20.

The first molding part 200 and the second molding part 300 are coupled with each other to be rotatable based on one end and also restrain the spring member 400. Also, the first molding part 200 and the second molding part 300 are provided to minimize torsion occurring when operating the spring member 400, and flow caused by the torsion.

The first molding part 200 and the second molding part 300 may be formed by general molding injection. The shape and structure of each of the first molding part 200 and the second molding part 300 may be variously modified according to the structure and the design specification of the spring member 400.

The first molding part 200 may be directly coupled with the second molding part 300 to be rotatable with respect to the second molding part 300. Depending to embodiments, the first molding part 200 and the second molding part 300 may be indirectly coupled with each other via a separate coupling member such as a bussing, a pin, and the like.

Hereinafter, an example where a round portion 210 is formed in the end of the first molding part 200, and a rotation guide surface 310 is formed on the second molding part to guide the rotation of the round portion 300, whereby the first molding part 200 is coupled with the second molding part 300 to be rotatable with respect to the second molding part 300 via the round portion 210 and the rotation guide surface 310 will be described.

Desirably, the first molding part 200 and the second molding part 300 may be constructed to rotate on a single plane with maintaining a parallel state. Depending on embodiments, the first molding part 200 and the second molding part 300 may be constructed to rotate on different planes in a tilted state with respect to each other.

Also, a combining protrusion 312 may be formed in one side of the second molding part 300 to restrain separation of the first molding part 200. The combining protrusion 312 may be integrally formed with the second molding part 300 to partially cover the circumference and outer surface of the first molding part 200 and thereby restrain the separation of the first molding part 200 along a rotating axis direction. In addition, a number of protrusions 312 and a displacement structure may be variously modified according to the required condition and the design specification.

In the aforementioned embodiment, the combining protrusion 312 is formed only in the second molding part 300, but the present invention is not limited thereto. Specifically, the combining protrusion 312 may also be formed in the first molding part 200 to partially cover the circumference and outer surface of the second molding part 300.

A first receiving groove 220 may be formed in the first molding part 200 to receive at least one portion of the first spring arm 410, and a second receiving groove 320 may be formed in the second molding part 300 to receive at least one portion of the second spring arm 420. The first and the second spring arms 410 and 420 may be received in the first and the second receiving grooves 220 and 320 to thereby be fixed to the first and the second molding parts 200 and 300, respectively.

In this instance, it may be desirable that the first receiving groove 220 and the second receiving groove 320 are formed to include an opening in the facing direction. Specifically, the first receiving groove 220 may be formed in the outer surface of the first molding part 200, and the second receiving groove 320 may be formed in the outer surface of the second molding part 300 that is disposed in the opposite direction to the outer surface of the first molding part 200. The above structure enables the first and the second molding parts 200 and 300 to be disposed between the first and the second spring arms 410 and 420 and thus further stabilizes the coupling state of the first molding part 200 and the second molding part 300. Depending on embodiments, the first receiving groove and the second receiving groove 320 may be constructed to have the opening in the same direction.

*A scheme of fixing the first and the second spring arms 410 and 420 in the first and the second molding parts 200 and 300 respectively may be variously modified according to the required condition and the design specification.

For example, the first and the second spring arms 410 and 420 may be fixed in the first and the second receiving grooves 220 and 320, respectively, using a snap-fit combining scheme. For this, the first and the second molding parts 200 and 300 may further include snap-fit coupling portions 222 and 322 respectively so that the first and the second spring arms 410 and 420 may be fitted in the first and the second receiving grooves 220 and 320, respectively, through snap-fit coupling. The snap-fit coupling portions 222 and 322 provide an inlet less than the width of the first and the second receiving grooves 220 and 320 around the opening thereof, and thus may be elastically transformed when the first and the second spring arms 410 and 420 are inserted and detached. Depending on embodiments, it is possible to exclude the separate snap-fit coupling portion and directly fit the first and the second spring arms 410 and 420 in the first and the second receiving grooves 220 and 320, respectively, using an interference fit scheme.

Also, the first molding part 200 and the second molding part 300 may further include pivot coupling portions 240 and 340 respectively that are pivot coupled with the objects 10 and 20. Each of the pivot coupling portions 240 and 340 may be pivot coupled with a connecting hole 30 of each of the objects 10 and 20. The connecting hole 30 formed in each of the objects 10 and 20 may be formed in an approximate peanut shape and include an insertion hole 31 that is formed to have a little larger diameter (or corresponding diameter) than the pivot coupling portions 240 and 340, and a fixing hole 32 that is formed to have a diameter less than the insertion hole 31 and is connected to the insertion hole 31 to fix the pivot coupling portions 240 and 340. In this instance, it may be desirable to form the fixing hole 32 to have a circular surface larger than ½ circle so that the pivot coupling portions 240 and 340 from being separated toward the insertion hole 31.

Through the above structure, the pivot coupling portions 240 and 340 may be inserted via the insertion hole 310 with the relatively larger diameter. The pivot coupling portions 240 and 340 are inserted and then moved to the fixing hole 32 with the relatively smaller diameter, whereby the pivot coupling portions 240 and 340 may be pivot coupled with the connecting hole 30.

The pivot coupling portions 240 and 340 may be separately disposed in the first molding part 200 and the second molding part 300, respectively. Desirably, the pivot coupling portions 240 and 340 may be manufactured together when the first molding part 200 and the second molding part 300 are formed by molding injection in order to simplify the structure and manufacturing process.

The spring member 400 includes the first spring arm 410 that is fixed to the first molding part 200 and the second spring arm 420 that is fixed to the second molding part 300. The first spring arm 420 and the second spring arm are integrally connected to each other. The spring member 400 may be formed by curving a wire rod of a predetermined thickness. The shape and structure of the spring member 400 may be variously modified according to the required condition and the design specification.

Also, the spring member 400 may further include a coil elastic portion that is integrally connected between the first spring arm 410 and the second spring arm 420. Specifically, the coil elastic portion 430 may be formed in a spiral shape by curving the wire rod of the predetermined thickness. One end of the coil elastic portion 430 is integrally connected to the first spring arm 410, and another end of the coil elastic portion 430 is integrally connected to the second spring arm 420. In this instance, an angle between the first and the second spring arms 410 and 420 and the displacement structure thereof may be variously modified according to the required condition and the design specification.

The structure and the shape of the coil elastic portion 430 formed in the spiral shape may also be variously modified according to the required condition and the design specification. Hereinafter, an example where the first coil elastic portion includes a first outer coil 432, an inner coil 434, and a second outer coil 436 will be described in detail.

The first outer coil 432 is wound to have a predetermined winding diameter and one end of the first outer coil 432 is integrally connected to the first spring arm 410.

The inner coil 434 is wound to have a relatively smaller winding diameter than the first outer coil 432 and one end of the inner coil 434 is integrally connected to another end of the first outer coil 432.

The second outer coil 436 is wound to have a relatively larger winding diameter than the inner coil 434, and one end of the second outer coil 436 is integrally connected to another end of the inner coil 434 and another end of the second outer coil 436 is integrally connected to the second spring arm 420.

The first and the second outer coils 432 and 436 may be closely disposed, and the inner coil 434 may be disposed inside the first and the second outer coils 432 and 436. Therefore, the spring member 400 may provide elasticity of greater than a predetermined level without increasing the thickness. Specifically, since the coil elastic portion 430 includes the first and the second outer coils 432 and 436, and the inner coil 434, it is possible to provide elasticity corresponding to general two springs. On the other hand, as the inner coil 434 is disposed inside each of the first and the second outer coils 432 and 436, the entire thickness of the spring member 400 may be determined based on the thickness of the first and the second outer coils 432 and 436, without increasing the thickness according to the inner coil 434.

Desirably, the first outer coil 432 and the second outer coil 436 may be formed to have a corresponding wiring diameter and may also be formed to have different winding diameters.

In the aforementioned embodiment, a number of windings for each of the first and the second outer coils 432 and 436, and the inner coil 434 is a single, but the present invention is not limited thereto or restricted thereby. Depending on embodiments, the number of windings for each of the first and the outer coils 432 and 436, and the inner coil 434 may be plural.

Also, a fixed curved portion 411 or 421 in an approximate L shape may be formed in at least one of one ends of the first and the second spring arms 410 and 420. In this case, the first and the second receiving grooves 220 and 320 may be formed in a shape corresponding to the fixed curved portions 411 and 421. The fixed curved portions 411 and 421 may restrain torsion and twist of the spring member 400 to thereby stably maintain the installation state of the spring member 400.

According to an embodiment of the present embodiment, the coil elastic portion 430 including the first and the second outer coils 432 and 436, and the inner coil 434, the first spring arm 410, and the second spring arm 420 are separate independent constituent elements, but the present invention is not limited thereto. Specifically, the coil elastic portion 430, and the first and the second spring arms 410 and 420 may be provided in an single integrated structured by consecutively curving a single wire rod.

The first molding part 200 may include a first receiving hole 230 to receive the coil elastic portion 430, and the second molding part 300 may include a second receiving hole 330 to receive the coil elastic portion 430. Also, the first receiving hole 230 and the second receiving hole 330 may have a corresponding diameter. The first and the second receiving holes 230 and 330 may be connected to each other.

In the aforementioned embodiment, it has been described that the first and the second spring arms 410 and 420 are coupled with the first and the second molding parts 200 and 300 by simply inserting the first and the second spring arms 410 and 420 into the first and the second receiving grooves 220 and 320 from the outside of the first and the second molding parts 200 and 300. Unlike this, the first and the second spring arms 410 and 420 may be coupled with the first and the second molding parts 200 and 300 using a suspend-inserting scheme.

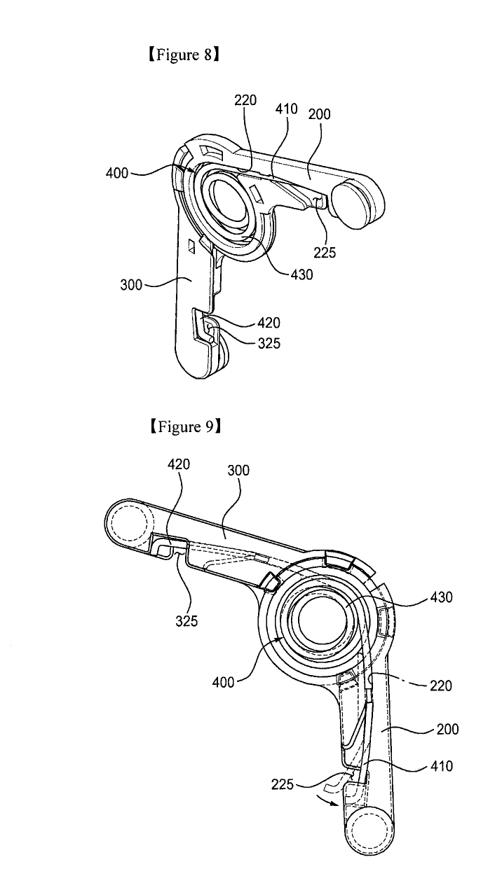

FIG. 8 is a perspective view illustrating the structure of an actuator according to another embodiment of the present invention, and FIG. 9 is a top-plane view illustrating the structure of an actuator according to another embodiment of the present invention. Like reference numerals refer to the like elements. Further detailed descriptions related thereto will be omitted here.

As shown in FIGS. 8 and 9, first and second molding parts 200 and 300 may further include suspend-inserting grooves 225 and 325 that are formed on their side to be connected with corresponding receiving grooves 220 and 320, respectively.

Through the above structure, in a state where spring arms 410 and 420 are partially fitted in the receiving grooves 220 and 320 respectively and ends of the spring arms 410 and 420 are curved in a predetermined angle, the spring arms 410 and 420 may be inserted into the suspend-inserting grooves 225 and 325 from the side of the first and the second molding parts 200 and 300 and thereby be fixed.

In addition, since the ends of the spring arms 410 and 420 may be disposed in a suspending state to the suspend-inserting grooves 225 and 325, it is possible to prevent the spring arms 410 and 420 from being separated from the first and the second molding parts 200 and 300 due to the operational impact.

In addition to the above scheme, the spring arms 410 and 420 may be fixed to the first and the second molding parts 200 and 300 via a separate coupling member.

Hereinafter, an actuator according to another embodiment of the present invention will be described.

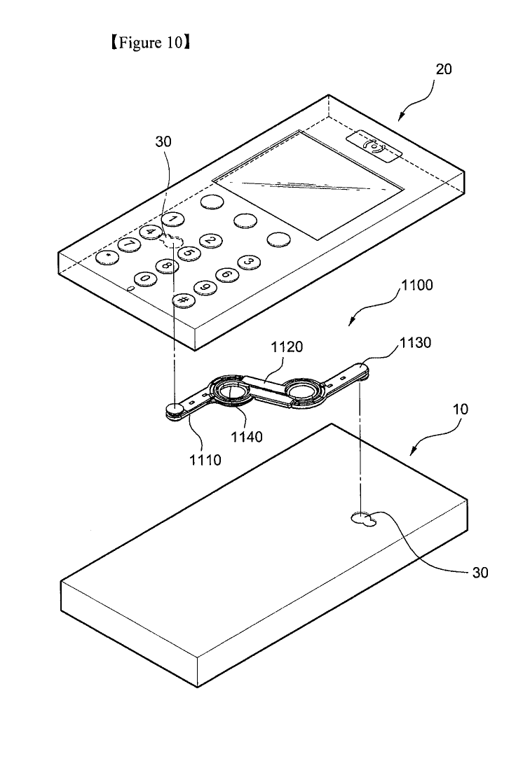

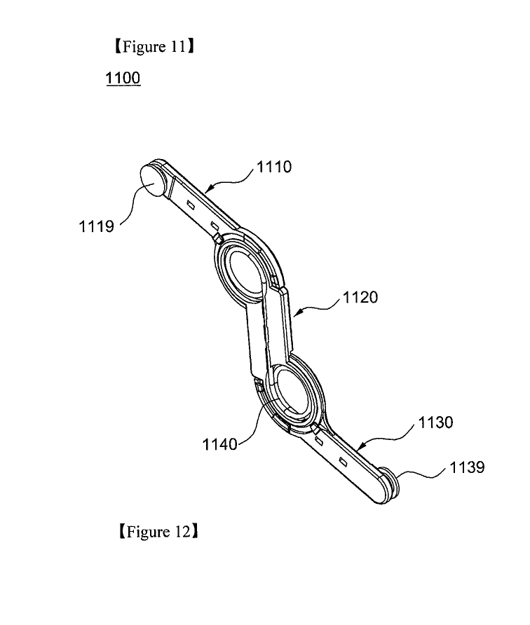

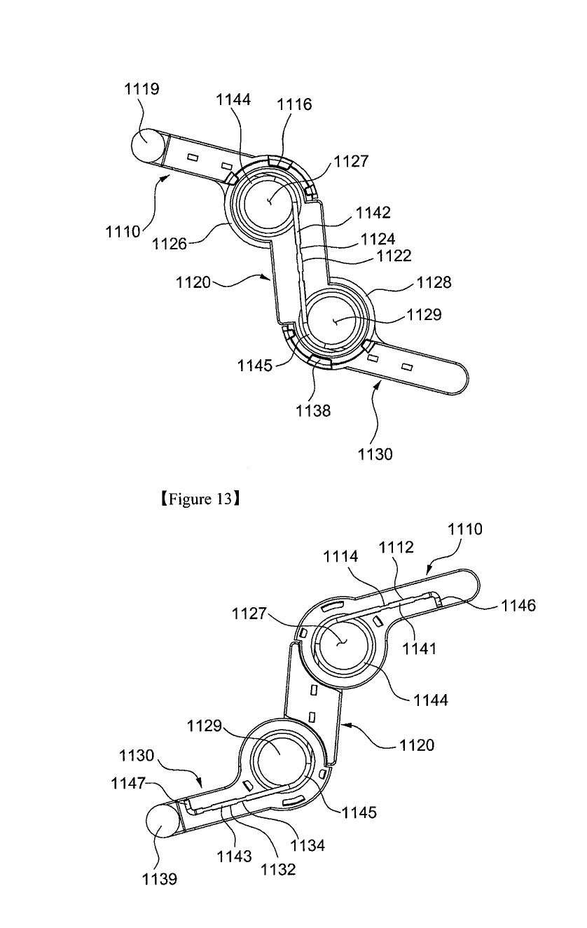

FIG. 10 is an exploded-perspective view for describing a portable device adopting an actuator according to an embodiment of the present invention, FIG. 11 is a perspective view for describing the actuator shown in FIG. 10, FIG. 12 is a top-plane view for describing the actuator shown in FIG. 11, and FIG. 13 is a rear view for describing the actuator shown in FIG. 11.

Referring to FIG. 10, an actuator 1100 according to the present embodiment may be installed to a slide-type terminal. Specifically, the actuator 1100 may be disposed between a body portion 10 and a sliding portion 20. As shown in FIG. 10, the actuator 1100 may be directly installed to a terminal body via an installation hole 30 of the body portion 10 and the sliding portion 20 and may also be indirectly installed to the body portion 10 and the sliding portion 20 via a separate slide hinge.

The actuator 1100 may provide elasticity between the body portion 10 and the slide portion 20. Also, when a user slides up the slide portion 20 by a predetermined interval, the actuator 1100 may provide a driving force so that a remaining interval may be automatically moved.

Referring to FIGS. 11 through 13, the actuator 1100 includes a first molding part 1110, a second molding part 1120, a third molding part 1130, and a spring member 1140. The first molding part 1110 and the second molding part 1120 are coupled with each other to be rotatable with respect to each other. On the opposite side, the second molding part 1120 and the third molding part 1130 are coupled with each other to be rotatable with respect to each other. In this instance, coupling may be performed to enable sliding between both elements and also may provide a restraining relationship capable of at least preventing separation.

The spring member 1140 includes a first spring arm 1141, a first coil elastic portion 1144, a second spring arm 1142, a second coil elastic portion 1145, and a third spring arm 1143. The above elements are integrally formed using a single wire. The first coil elastic portion 1144 and the second coil elastic portion 1145 are wound at least once to thereby provide elasticity by torsion transformation. In the present embodiment, the spring member 1140 includes the same two coil elastic portions, but the present invention is not limited thereto. The coil elastic portions may have different diameters and a different number of windings. Also, spring arms may be connected in a curve-enabled shape without using the coil elastic portions.

Referring again to FIGS. 11 through 13, the first molding part 1110 includes a first receiving groove 1112 or an opening that is formed to face the front. The first spring arm 1141 is inserted into and fixed to the first receiving groove 1112. The second molding part 1120 includes a second receiving groove 1122 that is formed to face the rear. The second spring arm 1142 is inserted into and fixed to the second receiving groove 1122. The third molding part 1130 includes a third receiving groove 1132 that is formed to face the front. The third spring arm 1143 is inserted into and fixed to the third receiving groove 1132. Specifically, the first receiving groove 1112 and the third receiving groove 1132 are open in the facing direction with respect to the second receiving groove 1122. The first to the third spring arms 1141, 1142, and 1143 may be inserted into corresponding receiving grooves via open portions. Consequently, the spring member 1140 passes through the first to the third molding parts 1110, 1120, and 1130 in a zigzagged shape, which results in structurally preventing the first to third molding parts 1110, 1120, and 1130 from being separated from each other.

Pivot coupling portions 1119 and 1139 are formed in ends of the first molding part 1110 and the third molding part 1130 respectively to face the opposite direction. As shown in FIG. 10, the pivot coupling portions 1119 and the 1139 may be inserted into and fixed to the installation hole 30 of the body portion 10 or the sliding portion 20. Also, an end of a molding part may be formed in a rotatable structure using various types of schemes.

The first molding part 1110 and the second molding part 1120 are coupled with each other to be rotatable with respect to each other based on one end thereof. The second molding part 1120 and the third molding part 1130 are also coupled with each other to be rotatable with respect to each other based on one end thereof. Also, the first to the third molding parts 1110, 1120, and 1130 are coupled with each other by the spring member 1140 that passes through them in the zigzagged shape and is fixed thereto. Even when the actuator 1100 operates, it is possible to minimize torsion or irregular flow of the spring member 1140.

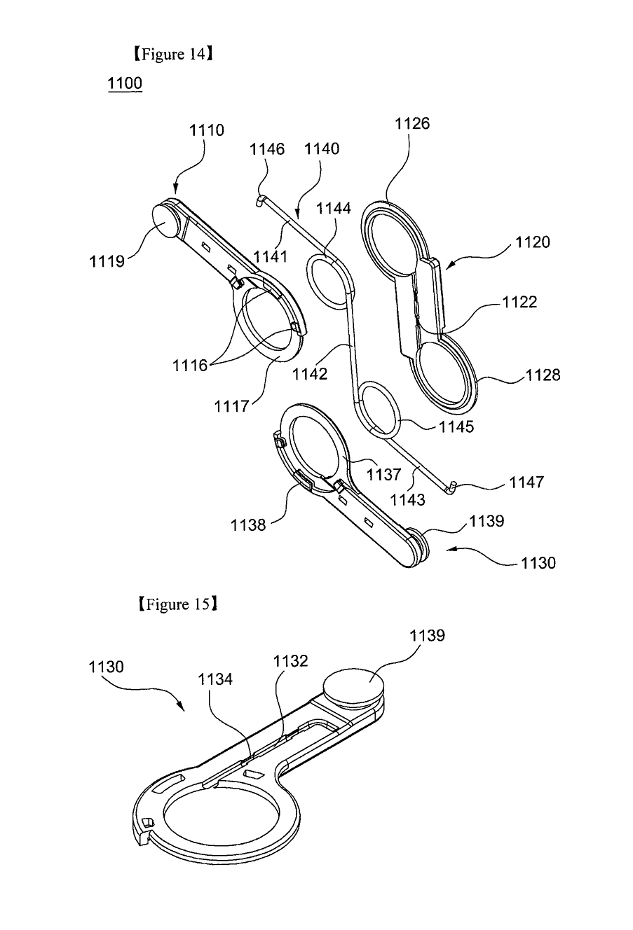

FIG. 14 is an exploded-perspective view of the actuator 1100 shown in FIG. 11, and FIG. 15 is a perspective view for describing the third molding part 1130 of the actuator 1100 shown in FIG. 11.

Referring to FIGS. 14 and 15, the first to the third molding parts 1110, 1120, and 1130 may be coupled with each other without using a separate combining tool such as a screw. The first molding part 1110, the second molding part 1120, and the third molding part 1130 may be formed by general molding injection. The shape and the structure of each of the first to the third molding parts 1110, 1120, and 1130 may be variously modified according to the structure and the design specification of the spring member 1140.

The first molding part 1110 may be directly coupled with the second molding part 1120 to be rotatable with respect to the second molding part 1120. For this, a first round portion 1126 is formed in one end of the second molding part 1120 and in correspondence to the first round portion 1126, a first rotation guide surface 1117 is provided in the first molding part 1110. Also, it may be desirable that the first molding part 1110 and the second molding part 1120 are constructed to rotate on a single plane with maintaining a parallel state. Depending on embodiments, the first molding part 1110 and the second molding part 1120 may be constructed to rotate on different planes in a tilted state with respect to each other.

A first combining protrusion 1116 may be formed in one side of the first molding part 1110 in order to prevent separation from the second molding part 1120. The first combining protrusion 1116 may be integrally formed with the first molding part 1110 to partially cover the circumference and outer surface of the first round portion 1126. The first combining protrusion 1116 and the first rotation guide surface 1117 may enable the first round portion 1126 to stably rotate. In addition, a number of first combining protrusions 1116 and a displacement structure thereof may be variously modified according to the required condition and the design specification.

The second molding part 1120 also may be directly coupled with the third molding part 1130 to be rotatable with respect to the third molding part 1130. For this, a second round portion 1128 is formed in another end of the second molding part 1120 and in correspondence to the second round portion 1128, a second rotation guide surface 1137 is provided in the third molding part 1130. Also, the second molding part 1120 and the third molding part 1130 may be constructed to rotate on a single plane with maintaining a parallel state. A second combining protrusion 1138 may be formed in one side of the third molding part 1130 in order to prevent separation from the second molding part 1120. The second combining protrusion 1138 may be integrally formed with the third molding part 1130 to partially cover the circumference and outer surface of the second round portion 1128. The second combining protrusion 1138 and the second rotation guide surface 1137 may enable the second round portion 1128 to stably rotate.

A first receiving hole 1127 (see FIG. 12) for internally receiving the first coil elastic portion 1144 may be formed in the first round portion 1126 as a rotation center of the first molding part 1110 and the second molding part 1120. A second receiving hole 1129 (see FIG. 12) for internally receiving the second coil elastic portion 1145 may be formed in the second round portion 1128 as a rotation center of the second molding part 1120 and the third molding part 1130. The first receiving hole 1127 and the second receiving hole 1129 may correspond to a space for receiving the coil elastic portions 1144 and 1145, and may also provide a space that allows motion of a spring arm when curving between spring arms, even without the coil elastic portion.

In the figure, a combining protrusion is formed in only the first molding part 1110 and the third molding part 1130, but the present invention is not limited thereto. Specifically, the combining protrusion may be formed in the second molding part 1120. Also, both the facing molding parts may provide a round portion, a rotation guide surface, and a combining protrusion.

Referring again to FIG. 15, the third receiving groove 1132 may be formed in the third molding part 1130 to insert and fix the third spring arm 1143 (see FIG. 14). The third receiving groove 1132 may receive and fix the entire or a portion of the third spring arm 1143. The third spring arm 1143 is received in the third receiving groove 1132. In order to fix the received third spring arm 1143, a snap-fit coupling portion 1134 using a snap-fit coupling scheme may be formed in the third receiving groove 1132. The snap-fit coupling portion 1134 may be internally protruded around an open portion of the third receiving groove 1132 and provide an inlet less than the width of the third receiving groove 1132. Therefore, once the third spring arm 1143 is inserted into the third receiving groove 1132, the snap-fit coupling portion 1134 may prevent separation of the third spring arm 1143.

The above receiving groove coupling and snap-fit coupling scheme may be applicable to the first and the second molding parts 1110 and 1120. Snap-fit coupling portions 1114 and 1124 may be formed in the first receiving groove 1112 and the second receiving groove 1122, respectively. Depending on embodiments, it is possible to exclude a separate snap-fit coupling portion and fix each spring arm in each corresponding receiving groove using an interference fit scheme.

As shown in FIGS. 14 and 15, fixed curved portions 1146 and 1147 in an L shape may be provided in a free end of the first spring arm 1141 and the third spring arm 1143, respectively. The fixed curved portions 1146 and 1147 are used to more firmly fix the spring member 1140 in the first molding part 1110 and the third molding part 1130, and may maximally restrict a torsion motion of the spring member 1140 in the molding part. For this, the first receiving groove 1112 and the third receiving groove 1132 are curved in the L shape to fit the curved fixed portions 1146 and 1147, respectively.

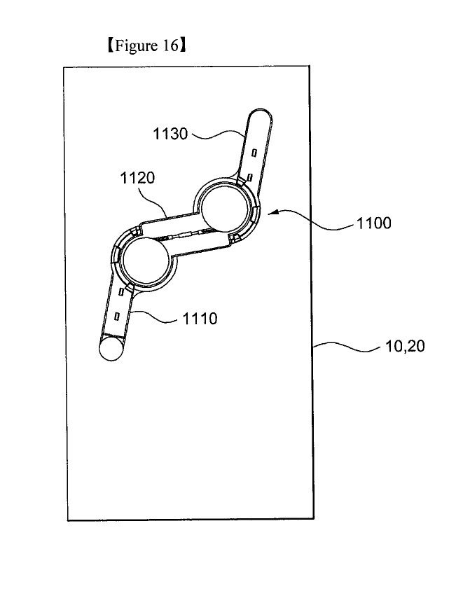

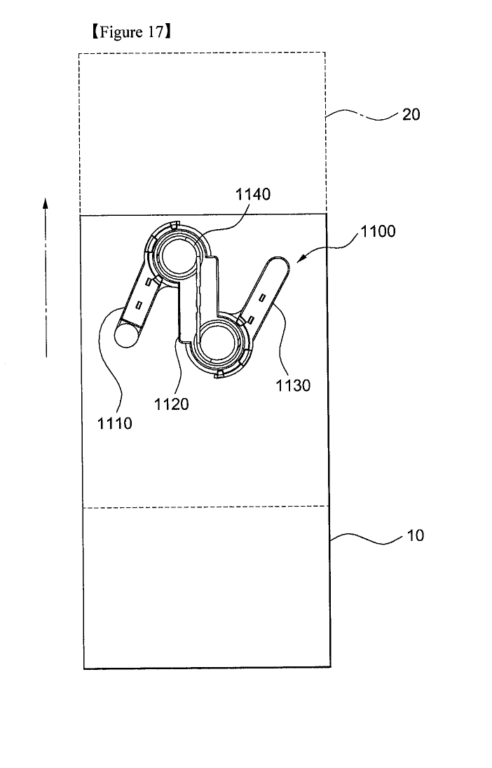

FIGS. 16 and 17 are top-plane view for describing the operation of the portable device and the actuator shown in FIG. 10.

Referring to FIG. 16, in a state where the sliding portion 20 of the portable device is closed, an approximate maximum distance may be maintained between the end of the first molding part 1110 and the end of the third molding part 1130. In this instance, the spring member 1140 may provide repulsive force between two ends to thereby enable the portable device to maintain the closed state.

Referring to FIG. 17, a user may slide up the sliding portion 20. In this instance, the first molding part 1110 and the third molding part 1130 are curved into the opposite direction based on the second molding part 1120, whereby the distance between the two ends is reduced. The flow of the spring member 1140 may be stably restricted by the first to the third molding parts 1110, 1120, and 1130. Also, the flow of the spring member 1140 may move in parallel with maintaining the nearly same plane.

In this instance, the molding part may be molded by using a lubricant material such as polyacetal (POM). The actuator 1110 may smoothly operate, maintaining the plane.

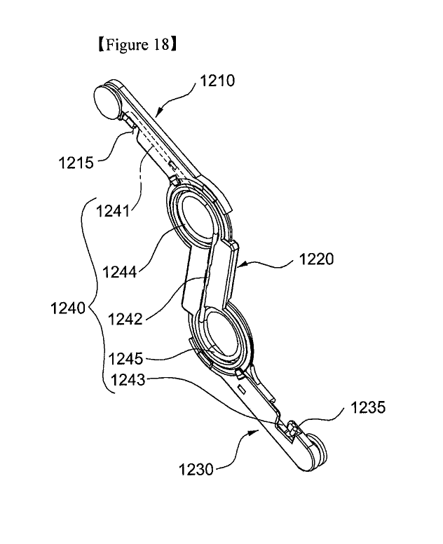

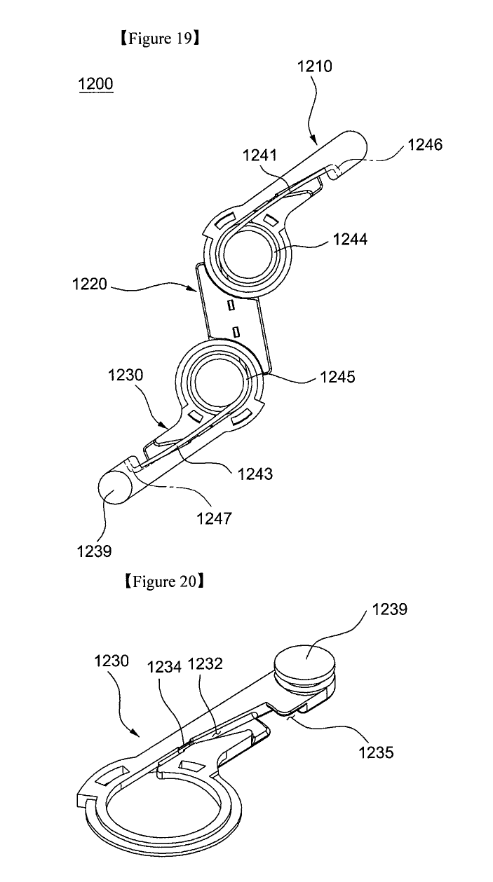

FIG. 18 is a perspective view for describing an actuator according to another embodiment of the present invention, and FIG. 19 is a rear view for describing the actuator shown in FIG. 18.

An actuator 1200 according to the present embodiment may also be installed to a slide-type terminal. Specifically, the actuator 1200 may be directly or indirectly disposed between a body portion and a sliding portion.

Referring to FIGS. 18 and 19, the actuator 1200 includes a first molding part 1210, a second molding part 1220, a third molding part 1230, and a spring member 1240. The first molding part 1210 and the second molding part 1220 are coupled with each other to be rotatable with respect to each other. On the opposite side, the second molding part 1220 and the third molding part 1230 may be coupled with each other to be rotatable with respect to each other. The spring member 1240 includes a first spring arm 1241, a first coil elastic portion 1244, a second spring arm 1242, a second coil elastic portion 1245, and a third spring arm 1243. The above elements are integrally formed using a single wire. The first coil elastic portion 1244 and the second coil elastic portion 1245 are wound at least once to thereby provide elasticity by torsion transformation.

The first molding part 1210 includes a first receiving groove or an opening that is formed to face the rear, and the first spring arm 1241 is inserted into and fixed to the first receiving groove. Also, the second molding part 1220 includes a second receiving groove that is formed to face the front, and the second spring arm 1242 is inserted into and fixed to the second receiving groove. On the contrary, the third molding part 1230 includes a third receiving groove that is formed to face the front, and the third spring arm 1243 is inserted into and fixed to the third receiving groove.

The first molding part 1210 and the second molding part 1220 are coupled with each other to be rotatable with respect to each other based on one end thereof. The second molding part 1220 and the third molding part 1230 are also coupled with each other to be rotatable with respect to each other based on one end thereof Also, the first to the third molding parts 1210, 1220, and 1230 are coupled with each other by the spring member 1240 that passes through them in the zigzagged shape and is fixed thereto. Even when the actuator 1200 operates, it is possible to minimize torsion or irregular flow of the spring member 1240.

FIG. 20 is a perspective view for describing the third molding part 1230 shown the actuator 1200 of FIG. 18.

Referring to FIGS. 18 through 20, the first to the third molding parts 1210, 1220, and 1230 may be coupled with each other without using a separate combining tool such as a screw. The first molding part 1210, the second molding part 1220, and the third molding part 1230 may be formed by general molding injection. The shape and the structure of each of the first to the third molding part 1210, 1220, and 1230 may be variously modified according to the structure and the design specification of the spring member 1240.

The receiving groove formed in the first molding part 1210 is connected to a first suspend-inserting groove 1215 formed on one side. The receiving groove formed in the third molding part 1230 is connected to a second suspend-inserting groove 1235 formed on opposite side. Therefore, the first spring arm 1241 may be easily guided into the receiving groove via the first suspend-inserting groove 1215. An end 1246 of the guided first spring arm 1241 is curved in the L shape to thereby be stably fixed within the receiving groove. Also, the third spring arm 1243 may be easily guided in the receiving groove via the second suspend-inserting groove 1235. An end 1247 of the guided third spring arm 1243 is curved in the L shape to thereby be stably fixed within the receiving groove.

A receiving hole capable of receiving the first coil elastic portion 1244 is provided as a rotation center of the first molding part 1210 and the second molding part 1220. Another receiving hole capable of receiving the second coil elastic portion 1245 is provided as a rotation center of the second molding part 1220 and the third molding part 1230. The receiving hole may correspond to a space for receiving the coil elastic portions 1244 and 1245, and may also provide a space that allows motion of a spring arm when curving between spring arms, even without the coil elastic portion.

*Referring to FIG. 20, a third receiving groove 1232 may be formed in the third molding part 1230 to insert and fix the third spring arm 1243 (see FIG. 19). The third receiving groove 1232 may receive and fix the entire or a portion of the third spring arm 1243. The third spring arm 1243 is received in the third receiving groove 1232. Also, the second suspend-inserting groove 1235 may be formed in an end of the third receiving groove 1232 to fix the curved end of the third spring arm 1243. A pivot coupling portion 1239 is formed in an end of the third molding part 1230. Like the aforementioned embodiment, the pivot coupling portion 1239 may be rotatably coupled with an installation hole of a body or a slide hinge.

In order to fix the received third spring arm 1243, a snap-fit coupling portion 1234 using a snap-fit coupling scheme may be formed in the third receiving groove 1232. The above receiving groove coupling and snap-fit coupling scheme may be applicable to the first and the second molding parts 1210 and 1220. It is possible to a receiving groove and a snap-fit coupling portion using a similar scheme. Depending on embodiments, it is possible to exclude a separate snap-fit coupling portion and fix each spring arm in each corresponding receiving groove using an interference fit scheme.

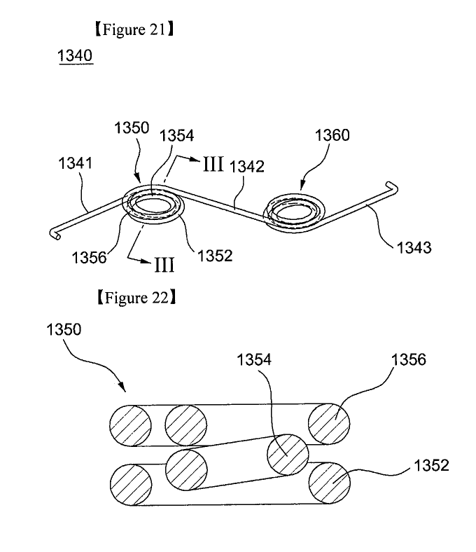

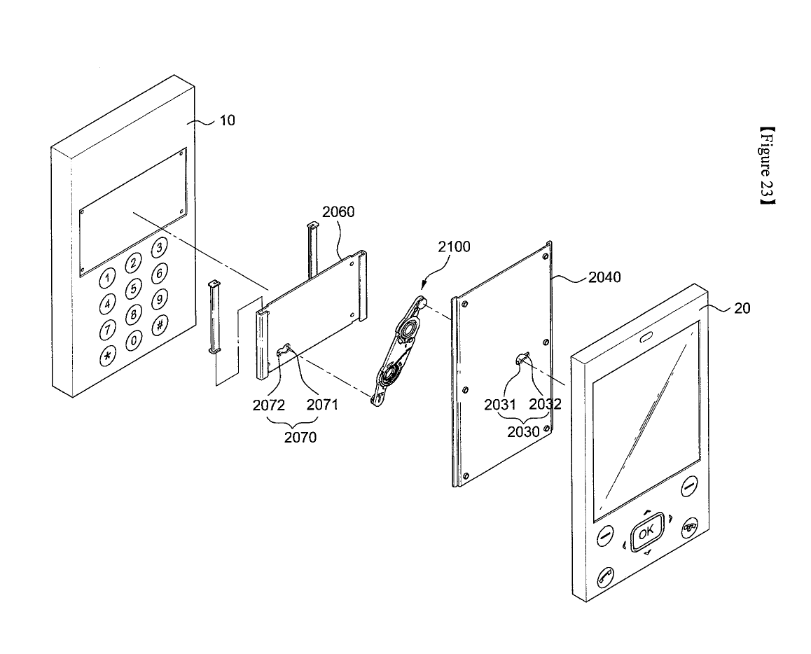

FIG. 21 is a perspective for describing a spring according to still another embodiment of the present invention, and FIG. 22 is a cross-sectional view cut along a line III-III for describing the spring shown in FIG. 21. Instead of a spring member fixed to a molding part described in the aforementioned embodiment, the spring specified by FIGS. 21 and 22 may be used. In addition, it is possible to manufacture the following spring using a conventional scheme and apply the spring for a semi-automatic sliding device.

Referring to FIGS. 21 and 22, a spring 1340 according to the present embodiment includes a first spring arm 1341, a second spring arm 1342, and a third spring arm 1343 that are connected to each other. A first coil elastic portion 1350 may be provided between the first and the second spring arms 1341 and 1342. A second coil elastic portion 1360 may be provided between the second and the third spring arms 1342 and 1343. Although the present embodiment provides the same type of coil elastic portions, the first and the second coil elastic portions 1350 and 1360 may be provided using different schemes or sizes.

Referring to FIG. 21, the first coil elastic portion 1350 includes a first outer coil 1352 that is connected to the first spring arm 1341, an inner coil 1354 that is connected to an end of the first outer coil 1352, and a second outer coil 1356 that is connected to another end of the inner coil 1354. The inner coil 1354 is formed to have the relatively smaller diameter so as to be positioned inside the outer coil. Also, the inner coil 1354 may connect the first and the second outer coils 1352 and 1356 to each other. The second outer coil 1356 is connected to the second spring arm 1342. The first and the second outer coils 1352 and 1356 may be closely disposed and approximately have the same diameter.

According to the present embodiment, a wire is wound once in the first outer coil 1352, is wound once in the inner coil 1354, and then is wound once in the second outer coil 1356, but the present invention is not limited thereto. Depending on embodiments, a number of windings for each of the outer coils and the inner coil may be variously determined.

The spring 1340 may be wound a large number of times within a size limited by the outer coil and the inner coil, and also may be formed in a small size based on the same number of windings. As described above, when increasing the number of windings and decreasing the size, there may be a disadvantage in that the spring 1340 may be irregularly flowing, but it may be partially solved by a molding part constructed as above.

Hereinafter, an actuator according to another embodiment of the present invention will be described.

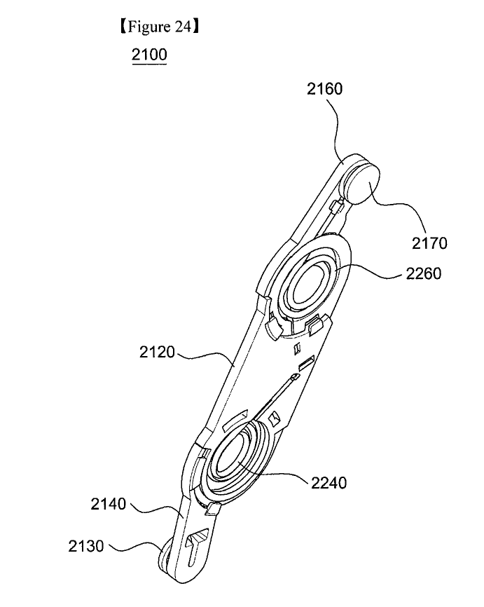

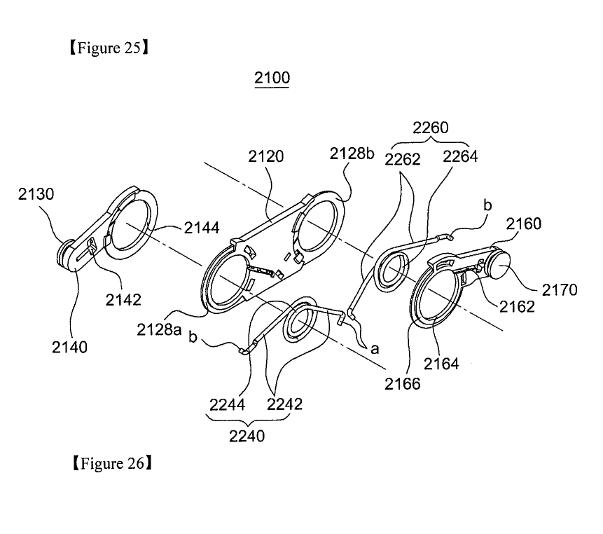

FIG. 23 is an exploded-perspective view illustrating a portable device adopting an actuator according to an embodiment of the present invention, FIG. 24 is a perspective view illustrating an actuator according to an embodiment of the present invention, and FIG. 25 is an exploded-perspective view of the actuator shown in FIG. 24.

Referring to FIG. 23, an actuator 2100 according to an embodiment of the present invention may be installed to a slide-type portable device. The portable device may include a body portion 10 and a sliding portion 20.

The actuator 2100 may be disposed between the body portion 10 and the sliding portion 20. Also, both ends of the actuator 2100 may be fixed to a rail plate 2040 and a guide plate 2060 so that the actuator 210 may be interposed between the body portion 10 and the sliding portion 20. When the portable device slides, the actuator 2100 may provide elasticity between the body portion 10 and the sliding portion 20. When a user slides up the sliding portion 20 by a predetermined interval, the actuator 2100 may enable the sliding portion 20 to be semi-automatically open and closed in the remaining interval.

In the present embodiment, the rail plate 2040 is attached onto the rear surface of a case of the sliding portion 20 and the guide plate 2060 is fixed onto an upper portion of the top surface of the body portion 10. As shown in FIG. 23, the rail plate 2040 may be separated from the sliding portion 20 and be fixed, but also the rail plate 2040 may be manufactured into a case of the sliding portion 20, that is, a lower case. Also, depending on a location of a keypad, the rail plate may be attached to a body portion and the guide plate may be attached to a sliding portion.

Referring to FIGS. 24 and 25, the actuator 2100 according to an embodiment of the present invention includes a second molding part 2120, first and third molding parts 2140 and 2160, and first and second torsion springs 2240 and 2260.

The first molding part 2140 and the third molding part 2160 are coupled with each other to be rotatable with respect to each other based on the second molding part 2120, and also restrain the first and second torsion springs 2240 and 2260, and minimize torsion and up/down flow when the first and second torsion springs 2240 and 2260 operate.

The first molding part 2140 and the third molding part 2160 may be formed by general molding injection. The shape and the structure of the first and the third molding parts 2140 and 2160 may be variously modified according to the structure and the design specification of the first and the second torsion springs 2240 and 2260.

A first round portion (not shown) and a second round portion 2166 are formed in an end of the first and the third molding parts 2140 and 2160 respectively. First and second rotation guide surfaces 2128a and 2128b for guiding rotation of the first round portion and the second round portion 2166 are formed in the second molding part 2120. The first and the third molding parts 2140 and 2160 are coupled with each other to be rotatable in both sides of the second molding part 2120 via the round portions 2166, and the rotation guide surfaces 2128a and 2128b. However, depending on embodiments, the location of the round portion and the rotation guide surface may be changed.

Also, the first molding part 2140 and the third molding part 2160 may rotate on one plane in both ends of the second molding part 2120, and may rotate in one side region based on a long axis of the second molding part 2120, that is, within 180 degrees.

A first receiving groove 2142 may be formed in the first molding part 2140 to partially receive a first spring arm 2242. A second receiving groove 2162 may be formed in the third molding part 2160 to partially receive a second spring arm 2262. The first and the second spring arms 2242 and 2262 may be fixed to the first and the third molding parts 2140 and 2160, respectively, in such a manner that they are received in the first and the second receiving grooves 2142 and 2162 respectively.

In correspondence to the first receiving groove 2142, a groove for receiving the first spring arm 2242 may be formed in the second molding part 2120. Desirably, the above two grooves may be formed in the opposite direction. This is because the first molding part 2140 and the second molding part 2120 may be closely attached to each other due to the first spring arm 2242 of the first torsion spring 2240. Like this, in correspondence to the second receiving groove 2162, a groove for receiving the second spring arm 2262 may be formed in the second molding part 2120. This groove may also be formed in the opposite side to the second receiving groove 2162. However, the first and the second receiving grooves 2142 and 2162 may be formed in the same direction or in the different directions.

Also, first and second pivot coupling portions 2130 and 2170 may be provided in the first molding part 2140 and the third molding part 2160 to be pivot coupled with the rail plate 2040 and the guide plate 2060, respectively. The first and the second pivot coupling portions 2130 and 2170 may be formed in a rivet-head shape or a volt-head shape to thereby be pivot coupled with a first connecting hole 2030 of the rail plate 2040 and a second connecting hole 2070 of the guide plate 2060, respectively.

The first and the second connecting holes 2030 and 2070 formed in the rail plate 2040 and the guide plate 2060, respectively, may be formed in an approximate peanut shape where an insertion hole and a fixing hole are connected. For example, first and second insertion holes 2031 and 2071 may be formed in the first and second connecting holes 2030 and 2070, respectively, to have the same diameter as or at least larger diameter than the maximum diameter of the first and the second pivot coupling portions 2130 and 2170. First and second fixing holes 2032 and 2072 may be formed to have the diameter less than the maximum diameter of the first and the second pivot coupling portions 2130 and 2170, preferably, may be formed to have the diameter corresponding to the inner diameter of the first and the second pivot coupling portions 2130 and 2170. The first and the second fixing holes 2032 and 2072 that are substantially rotatably coupled with the first and the second pivot coupling portions 2130 and 2170 may be positioned in an outer location than the first and the second insertion holes 2031 and 2071, respectively.

The first and the second pivot coupling portions 2130 and 2170 may be easily inserted via the first and the second insertion holes 2031 and 2071 with the relatively larger diameter. By inserting the first and the second pivot coupling portions 2130 and 2170 into the first and the second insertion holes 2031 and 2071 and then moving the pivot coupling portions 2130 and 2170 to the first and the second fixing holes 2032 and 2072, the pivot coupling portions 2130 and 2170 may be pivot coupled with the first and the second connecting holes 2030 and 2070, respectively.

The pivot coupling portions 2130 and 2170 may be separately disposed in the first molding part 2140 and the third molding part 2160. Also, in order to simplify the structure and the manufacturing process, the pivot coupling portions 2130 and 2170 may be formed together when the first and the third molding parts 2140 and 2160 are formed by molding injection.

The first and the second torsion springs 2240 and 2260 include the first and the second spring arms 2242 and 2262 that are fixed to the first and the third molding parts 2140 and 2160, respectively. The first and the second torsion springs 2240 and 2260 may include first and second coil portions 2244 and 2264 in the middle of the first and the second spring arms 2242 and 2262, respectively by curving a wire rod of a predetermined thickness. The first and the second spring arms 2242 and 2262 may be provided in both ends based on the first and the second coil portions 2244 and 2264 that are positioned in the first and the round portions 2166. The shape and the structure of first and second coil portions 2244 and 2264, and first and second spring arms 2242 and 2262 may be variously modified according to the required condition and the design specification.

The first and the second coil portions 2244 and 2264 may be curved in the same direction with respect to the first and the second spring arms 2242 and 2262, respectively. Also, the central axis of the first and the second coil portions 2244 and 2264 may be curved to be parallel so that the first and the second torsion springs 2240 and 2260 may be positioned substantially in parallel with each other. In this instance, the first and the third molding parts 2140 and 2160 may be positioned in parallel to be provided according to the shape of the first and the second torsion springs 2240 and 2260.

L-shaped curved portions a and b may be formed in ends of the first and the second spring arms 2242 and 2262. In this instance, the curved portions a formed in one ends of the first and the second spring arms 2242 and 2262 to be coupled with the second molding part 2120 may be curved into the same direction as the curved direction of the first and the second coil portions 2244 and 2264, respectively. The curved portions b to be coupled with the first and the third molding parts 2140 and 2160 may be curved vertically with respect to the curved direction of the first and the second coil portions 2244 and 2264, respectively. In this case, the first and the second receiving grooves 2142 and 2162 may be formed in the shape corresponding to the curved portions a and b, respectively. The curved portions a and b may restrain torsion and twist of the spring member and stably maintain the installation state of the torsion spring.

The first molding part 2140 may include a first receiving hole 2144 capable of internally receiving the first coil portion 2244. The third molding part 2160 may also include a second receiving hole 2164 capable of internally receiving the second coil portion 2264. The first and the second receiving holes 2144 and 2164 may be formed to have the corresponding diameter. Also, the first and the second receiving holes 2144 and 2164 may be formed in facing locations.

In the aforementioned embodiment, each spring arm is inserted into each corresponding receiving groove from an outside of first and third molding parts, but the present invention is not limited thereto. Spring arms may be fixed to the first and the third molding parts respectively using a suspend-insertion scheme.

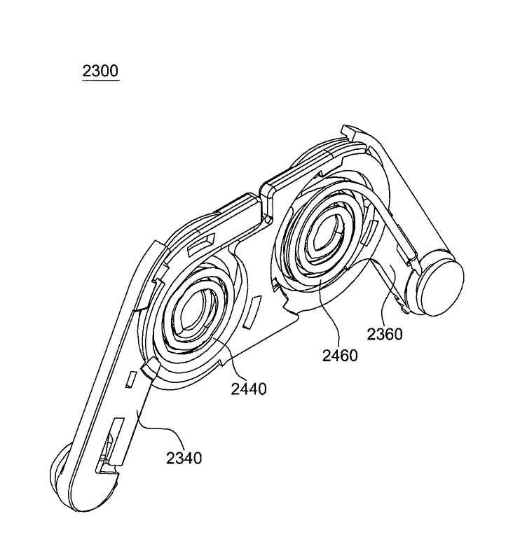

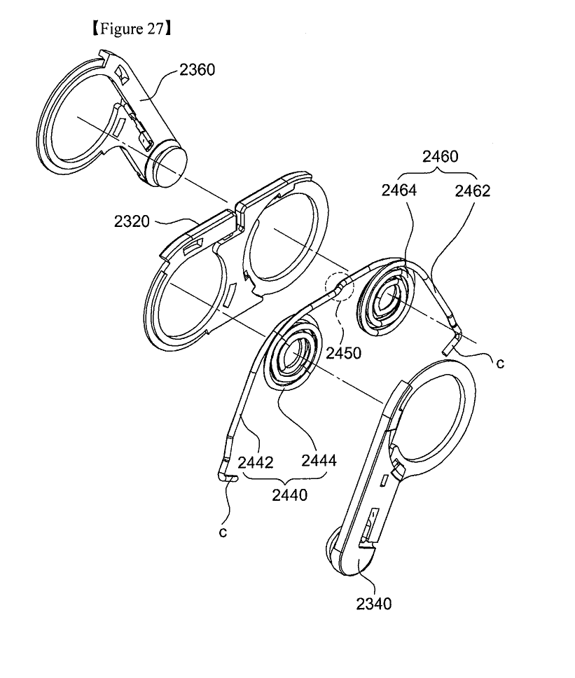

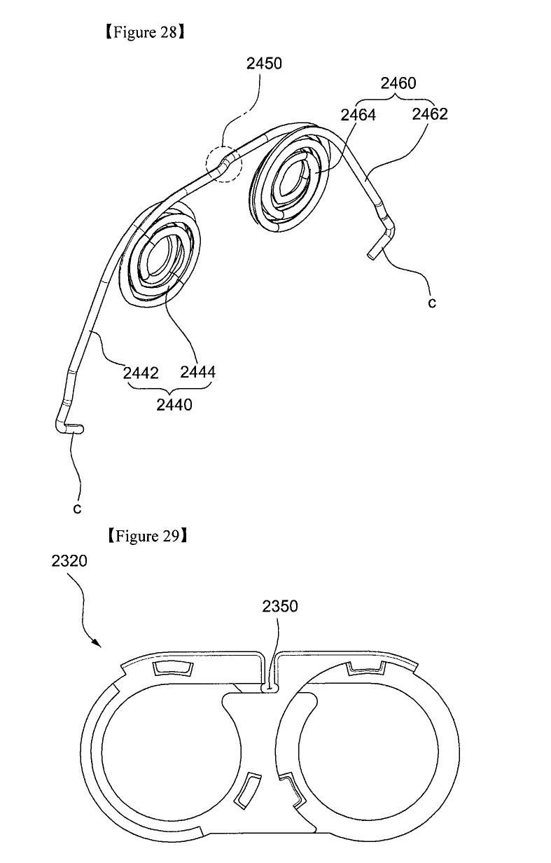

FIG. 26 is a perspective view illustrating the structure of an actuator according to another embodiment of the present invention, FIG. 27 is an exploded-perspective view of the actuator shown in FIG. 26, FIG. 28 is a perspective view illustrating a torsion spring of an actuator according to another embodiment of the present invention, and FIG. 29 is a perspective view illustrating a second molding part according to another embodiment of the present invention.

The same reference numerals refer to the like elements. Further detailed descriptions related thereto will be omitted here.

Referring to FIGS. 26 through 29, a first torsion spring 2440 and a second torsion spring 2460 may be adjacently disposed. A firs spring arm 2442 of a first coil portion 2444 adjacent to a second coil portion 2464 may be integrally connected to a second spring arm 2462 of the second coil portion 2464 adjacent to the first coil portion 2444 via a spring arm 2450.

The spring arm 2450 connecting outer ends of the first coil portion 2444 and the second coil portion 2464 may be formed in a common outer contact line of the outer ends of the first and the second coil portions 2444 and 2464. Specifically, the first coil portion 2444 and the second coil portion 2464 may be extended to the opposite direction based on the spring arm 2450. Here, it has been described that the spring arm 2450 is formed in the upper common outer line of the common outer line of the outer ends of the first and the second coil portions 2444 and 2464, but the present invention is not limited thereto or restricted thereby.

The spring arm 2450 may be formed in a curved shape. In correspondence to this structure, a second molding part 2320 may be formed with a slit 2350 through which the spring arm 2350 connecting the first and the second torsion springs 2440 and 2460 may pass. When the spring arm 2450 passes through the slit 2350, the first and the second torsion springs 2440 and 2460 may be positioned on the opposite surface. The slit 2350 may be variously modified according to the shape, the location, and the like of the spring arm 2450 connecting the first and the second torsion springs 2440 and 2460.

Also, one ends of the first and the second spring arms 2442 and 2462 may include curved portions c that are curved into the first and the second coil portions 2444 and 2464, respectively. The curved portions c may be rotatably fixed to the first and the third molding parts 2340 and 2360 via the first and the second spring arms 2442 and 2462, respectively.

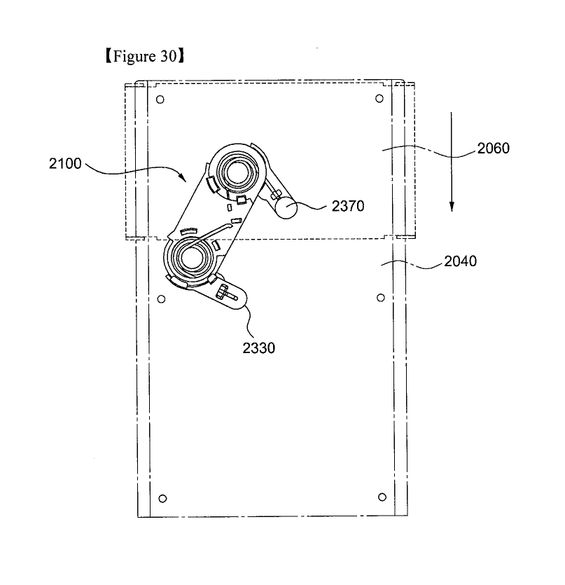

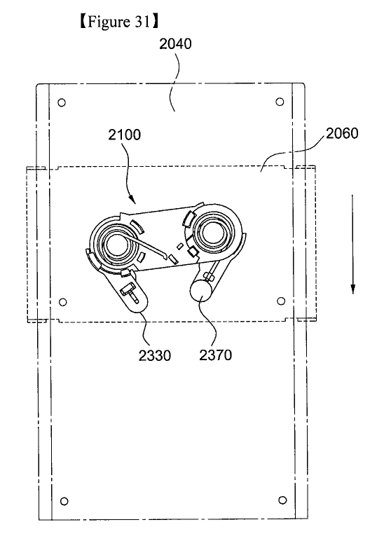

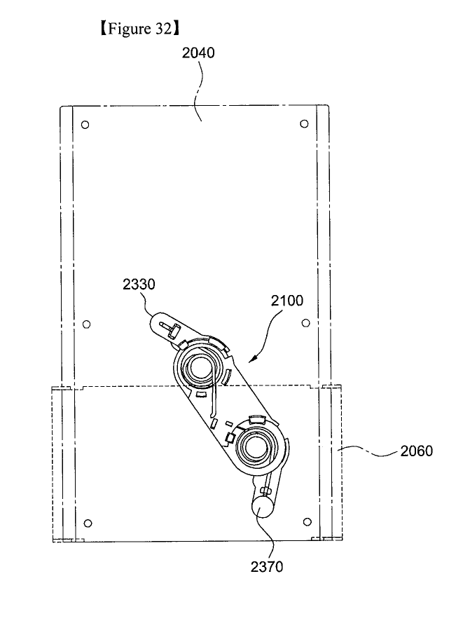

FIGS. 30 to 32 are top-plane views illustrating the operational structure of an actuator according to an embodiment of the present invention. The same reference numerals refer to the like elements. Further detailed descriptions related thereto will be omitted here.

As shown in FIGS. 30 through 32, the actuator 2100 may be disposed between the rail plate 2040 and the guide plate 2060.

Prior to describing the operation of the actuator 2100, the present invention will be described based on the actuator 2100 according to an embodiment of the present invention, but the slide of the portable device may be operable by the actuator 2300 according to another embodiment of the present invention. The present invention is not limited thereto or restricted thereto.

As the first pivot coupling portion 2130 is fixed in the first connecting hole 2030 and thereby the rail plate 2040 slides, the torsion springs 2240 and 2260 may accumulate elasticity until the actuator 2100 reaches a threshold location. When the actuator 2100 passes by the threshold location, the rail plate 2040 may semi-automatically slide in the remaining section after the threshold location while the torsion springs 2240 and 2260 are restored to an original location.

In this instance, the torsion springs 2240 and 2260 may provide a driving force for sliding movement of the portable device. The second molding part 2120, and the first and the third molding parts 2140 and 2160 may restrain the torsion and twist of the torsion springs 2240 and 2260 caused by elastic rotation of the torsion springs 2240 and 2260. Since the torsion and twist of the torsion springs 2240 and 2260 are overall restrained, the shape transformation in the shape of the torsion springs 2240 and 2260 may be reduced. Since the shape of the torsion springs 2240 and 2260 may be maintained, a sliding lifespan of the portable device may be improved.

The lengthwise width of each of the molding parts 2140 and 2160 may be uniformly formed based on the moving direction of the rail plate 2040. The above configuration is enabled since the torsion springs 2240 and 2260 are provided in parallel and the molding parts 2140 and 2160 are provided along the outer circumference of the torsion springs 2240 and 2260. In particular, the moving traffic line according to the elastic rotation of the actuator 2100 may depend on the shape of the torsion springs 2240 and 2260. In the case of a nearly linear actuator like an embodiment of the present invention, the moving traffic line according to the elastic rotation generally depends only on each spring arm and thus it is possible to improve the utilization of regions excluding the moving traffic line of each spring arm.

Hereinafter, an actuator according to another embodiment of the present invention will be described.

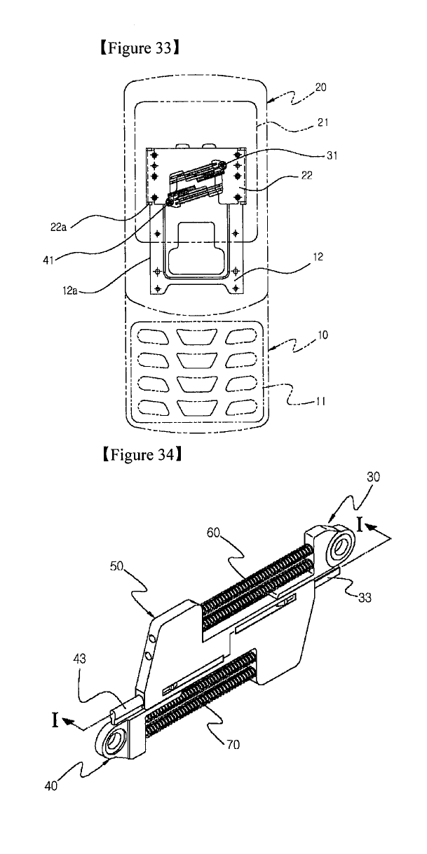

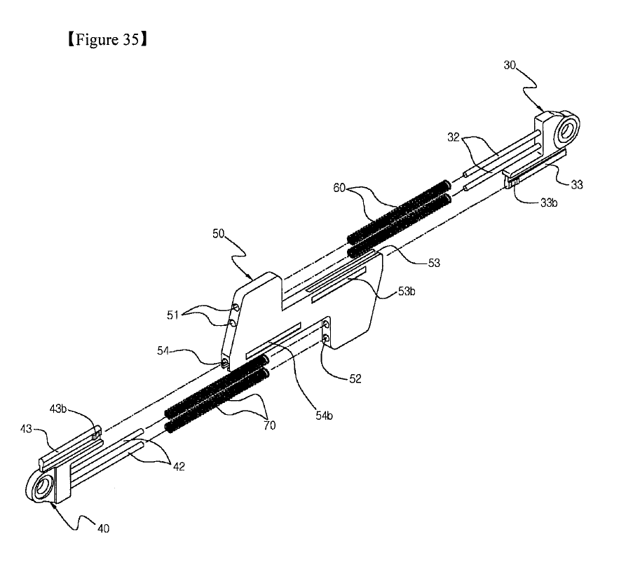

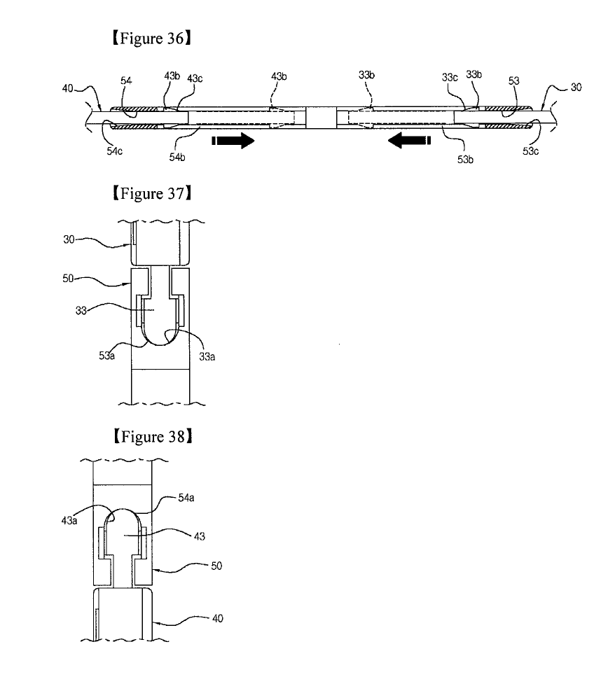

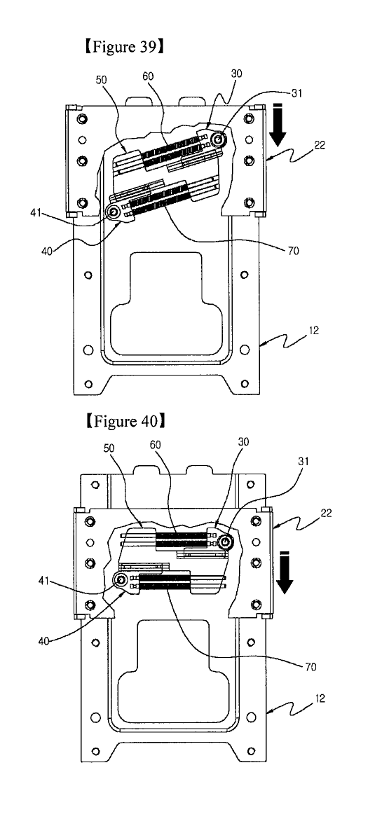

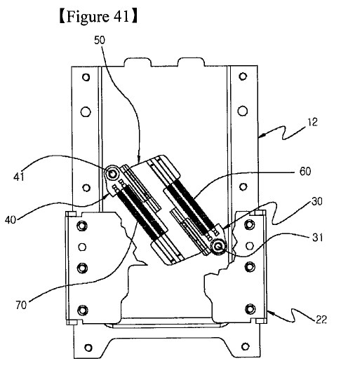

FIG. 33 is a front view illustrating an actuator of a slide-type mobile phone according to an embodiment of the present invention, FIG. 34 is a perspective view illustrating a coupled state of a slide-type mobile phone and an actuator according to an embodiment of the present invention, FIG. 35 is an exploded perspective view illustrating an actuator of a slide-type mobile phone according to an embodiment of the present invention, FIG. 36 is a cross-sectional view cut along a line I-I of FIG. 34, FIGS. 37 and 38 are partially enlarged views of a coupled state between first and second link plates and a connecting plate in an actuator of a slide-type mobile phone according to an embodiment of the present invention, and FIGS. 39 to 41 are operational diagrams sequentially illustrating an operational state of an actuator of a slide-type mobile phone according to an embodiment of the present invention.

As shown in FIGS. 33 through 38, the slide-type mobile phone includes a body 10 with a fixed frame 12, a cover 20 with a sliding frame 22 that is slidably coupled with the fixed frame 12, first and second link frames 30 and 40 that include first and second shafts 32 and 42 rotatably installed in the sliding frame 22 and the fixed frame 12, respectively, a connecting plating 50 that includes first and second guide holes 51 and 52 to guide the first and the second shafts 32 and 42, first and second compression coil springs 60 and 70 that are installed in the outer circumference of the first and the second shafts 32 and 42 respectively, and a flow preventing unit that prevents flow of the first and the second link plates 30 and 40 sliding in both sides of the connecting plate 50.

A keypad 11 is provided in a lower portion of the front surface of the body 10, and the fixed frame 12 is provided in an upper portion of the front surface of the body 10. A display portion 21 is provided on the front surface of the cover 20 and the sliding frame 22 is provided on the rear surface of the cover 20.

The fixed frame 12 includes a guide rail 12a in its both sides to be installed on the front surface of the body 10. The sliding frame 22 includes a rail groove 22a to be upwardly and downwardly slidable along the guide rail 12a of the fixed frame 12 and thereby is installed in the rear surface of the cover 20.

The first and the second link plates 30 and 40, and the connecting plate 50 connecting the first and the second link plates 30 and 40 are disposed between the fixed frame 12 and the sliding frame 22 that are coupled with the body 10 and the cover 20 respectively as described above. The first and the second link plates 30 and 40, and the connecting plate 50 are formed of thin plates in the same width.

The first link plate 30 is installed to be rotatable using a first pivot pin 31 formed in the right side of the sliding frame 22. A pair of first shafts 32 is provided to be parallel with the sliding frame 22. In this instance, the thickness of the first shaft 32 may be less than the thickness of the first link plate 30.

The second link plate 40 is installed to be rotatable using a second pivot pin 41 formed in the left side of the fixed frame 12. A pair of second shafts 32 is provided to correspond to but not to interrupt the pair of first shafts 32 of the first link plate 30.

A pair of first guide holes 51 is punctured in the upper left side of the connecting plate 50 to slidably guide the pair of first shafts 32 of the first link plate 30. A pair of second guide holes 52 is punctured in the lower right side of the connecting plate to slidably guide the pair of second shafts 42 of the second link plate 40.

The flow of the first link plate 30 and the second link plate 40 that slide and are guided in both sides of the connecting late 50 may be prevented by the flow preventing unit M. The flow preventing unit M includes a first guide rail 33 in the first link plate 30 along the axial direction of the first shaft 32, and forms a first flow preventing groove 53 in the connecting plate 50 to prevent flow when it is slidably coupled along the first guide rail 33. Also, the flow preventing unit M includes a second guide rail 43 in the second link plate 40 along the axial direction of the second shaft 42, and forms a second flow preventing groove 54 in the connecting plate 50 to prevent flow when it is slidably coupled along the second guide rail 43.

A first rounded surface 33a is formed in the first guide rail 33 to contact with one surface of the first flow preventing groove 53, and a first line contact surface 53a with a different circular arc is formed in the first flow prevent groove 53 to make line contact with the first rounded surface 33a of the first guide rail 33. Specifically, the circular arc of the rounded first line contact surface 53a is formed to be larger than the circular arc of the first rounded surface 33a whereby the first guide rail 33 sliding along the first flow preventing groove 53 makes line contact with the first rounded surface 33a.

Specifically, the first rounded surface 33a of the first guide rail 33 slides along the first line contact surface 53a of the first flow preventing groove 53 inducing the line contact. Therefore, in comparison to the contact surface, it is possible to reduce friction. Also, by inducing the sliding first guide rail 33 to the center of the first flow preventing groove 53, it is possible to prevent the sliding first link plate 33 from flowing into the left and right sides.

A first operating hole 53b is formed in both sides of the sliding direction of the first flow preventing groove 53, and a first stopper 33b is formed in both sides of the first guide rail 33 to slide along the first operating hole 53 and restrain separation of the first link plate 30. A graded first gradient surface 33c is formed in a front end of the first stopper 33b and a tapered first guide surface 53c is formed in an outer end of the first flow preventing groove 53 to guide entrance of the first gradient surface 33c.

Through the above construction, the first gradient surface 33c of the first stopper 33b enters along the first guide surface 53c to thereby be coupled with the first operating hole 53b. The coupled first stopper 33b slides along the first operating hole 53b to thereby prevent separation of the first link plate 30.

A second rounded surface 43a is formed in the second guide rail 43 to contact with one surface of the second flow preventing groove 54, and a second line contact surface 54a with a different circular arc is formed in the second flow prevent groove 54 to make line contact with the second rounded surface 43a of the second guide rail 43. Specifically, the circular arc of the rounded second line contact surface 54a is formed to be larger than the circular arc of the second rounded surface 43a whereby the second guide rail 43 sliding along the second flow preventing groove 54 makes line contact with the second rounded surface 54a.

Specifically, the second rounded surface 43a of the second guide rail 43 slides along the second line contact surface 54a of the second flow preventing groove 54 inducing the line contact. Therefore, in comparison to the contact surface, it is possible to reduce friction. Also, by inducing the sliding second guide rail 43 to the center of the second flow preventing groove 43, it is possible to prevent the sliding second link plate 40 from flowing into the left and right sides.

A second operating hole 54b is formed in both sides of the sliding direction of the second flow preventing groove 54, and a second stopper 43b is formed in both sides of the second guide rail 43 to slide along the second operating hole 54b and restrain separation of the second link plate 40. A graded second gradient surface 43c is formed in a front end of the second stopper 43b and a tapered second guide surface 54c is formed in an outer end of the second flow preventing groove 54 to guide entrance of the second gradient surface 43c.

Through the above construction, the second gradient surface 43c of the second stopper 43b enters along the second guide surface 54c to thereby be coupled with the second operating hole 54b. The coupled second stopper 43b slides along the second operating hole 54b to thereby prevent separation of the second link plate 40.

The first compression coil spring 60 is installed along the outer circumference of the first shaft 32 to elastically apply compression between the first link plate 30 and the connecting plate 50. One end of the first compression coil spring 60 is supported by the first link plate 30, and another end of the first compression coil spring is supported in an inner end of the first guide hole 51 punctured into the connecting plate 50.

The second compression coil spring 70 is installed along the outer circumference of the second shaft 42 to elastically apply compression between the second link plate 40 and the connecting plate 50. One end of the second compression coil spring 70 is supported by the second link plate 40, and another end of the second compression coil spring 70 is supported in an inner end of the second guide hole 52 punctured into the connecting plate 50.

When the first and the second compression coil springs 60 and 70 are elastically compressed, the flow may be prevented in every direction by the first and the second shafts 32 and 42.

Desirably, the outer diameter of the first and the second compression coil springs 60 and 70 may be less than or equal to the thickness of the first and the second link plates 30 and 40. Specifically, in a case where the outer diameter of the first and the second compression oil springs 60 and 40 is greater than the thickness of the first and the second link plates 30 and 40, when the cover 20 slides along the body 10, the cover 20 causes friction on the sliding frame 22 and the fixed frame 12 to thereby cause noise. Also, the thickness of the first and the second link plates 30 and 40, and the connecting plate 50 may be adjusted according to the outer diameter of the first and the second compression coil springs 60 and 70. Therefore, the thickness of the coupled fixed frame 12 and sliding frame 22 may be slimmed.

Accordingly, when a user applies a predetermined external force to the sliding frame 22, the sliding frame 22 may slide to up and down of the fixed frame 12. In this instance, the first and the second compression coil springs 60 and 70 are elastically compressed and apply elasticity to thereby slide the sliding frame 22 with a small force and to close and open the keypad 11 of the body 10 using the cover 20.

Hereinafter, the operational relationship of the present invention constructed as above will be described in detail with reference to the accompanying drawings FIGS. 39 through 41.

When applying a predetermined external force to the sliding frame 22 in the arrow direction shown in FIG. 39, the rail groove 22a formed in the sliding frame 22 slides along the guide rail 12a of the fixed frame 12. In this instance, as the first link late 30 rotates using the first pivot pin 31, the first shaft 32 slides along the first guide hole 51 of the connecting plate 50 and the first compression coil spring 60 is compressed as shown in FIG. 40. Also, while the second link plate 40 rotates using the second pivot pin 41, the second compression coil spring 70 is compressed.

The compressed first and second compression coil springs 60 and 70 exhibit elasticity to push the first and the second link plates 30 and 40, and the connecting plate 50 to both sides, whereby the cover 20 closes the keypad 11 of the body 10.

When sliding the sliding frame 22 according to the operation of the first and the second compression coil springs 60 and 70 as described above, the first and the second guide rails 33 and 43 slide along the first and the second flow preventing grooves 53 and 54 to prevent the flow of the first and the second link plates 30 and 40. Particularly, as the first and second rounded surfaces 33a and 43a slide along the first and the second line contact surfaces 53a and 54b inducing the line contact, the center of the first and the second guide rails 33 and 43 is induced toward the center of the first and the second flow preventing grooves 53 and 54. Through this, it is possible to prevent the first and the second link plates 30 and 40 sliding in both sides of the connecting plate 50 from flowing into the left and right sides of the sliding direction and also to reduce friction using the line contact.

As described above, according to the present invention, since first and second compression coil springs elastically applying compression force along the axial direction are adopted, it is possible to prevent friction between a fixed frame and a sliding frame. Also, it is possible to improve operational reliability by preventing the flow of sliding first and the second link plates.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

An actuator and a spring used for the actuator according to the present invention may be adopted for a slide-type portable device. Also, the actuator and the spring may be widely used for various types of devices and structures.

1. An actuator comprising:
a first molding part;
a second molding part being rotatably connected in an end of the first molding part; and
a spring member comprising a first spring arm that is fixed to the first molding part and a second spring arm that is fixed to the second molding part, wherein the first spring arm and the second spring arm are integrally connected to each other.

2. The actuator of claim 1, wherein the first molding part rotates to be parallel with respect to the second molding part.

3. The actuator of claim 1, wherein a round portion is formed in the end of the first molding part, and a rotation guide surface is formed on the second molding part to guide the rotation of the round portion.

4. The actuator of claim 3, wherein a combining protrusion is formed in one side of the second molding part to restrain separation of the first molding part.

5. The actuator of claim 1, wherein a first receiving groove is formed in the first molding part to receive at least one portion of the first spring arm, and a second receiving groove is formed in the second molding part to receive at least one portion of the second spring arm.

6. The actuator of claim 5, wherein the first receiving groove and the second receive groove are open in the facing direction.

7. The actuator of claim 5, wherein each of the first and the second molding parts further comprises a snap-fit coupling portion that is formed to snap-fit couple each spring arm in each corresponding receiving groove.

8. The actuator of claim 5, wherein each of the first and the second molding parts further comprises a suspend-inserting groove that is formed on its side to be connected with each corresponding receiving groove.

9. The actuator of claim 1, wherein each of the first and the second molding parts further comprises a pivot coupling portion that is pivot coupled with an object.

10. The actuator of claim 9, wherein the pivot coupling portion is formed together when the first and the second molding parts are formed by molding injection.

11. The actuator of claim 1, wherein the spring member further comprises a coil elastic portion that is integrally connected between the first spring arm and the second spring arm.

12. The actuator of claim 11, wherein the coil elastic portion comprises:
a first outer coil of which one end is connected to the first spring arm;
an inner coil having a relatively smaller winding diameter than the first outer coil and of which one end is connected to another end of the first outer coil; and
a second outer coil having a relatively larger winding diameter than the inner coil, and of which one end is connected to another end of the inner coil and another end is connected to the second spring arm,
wherein the first and the second outer coils are closely disposed, and the inner coil is disposed inside the first and the second outer coils.

13. The actuator of claim 12, wherein the first and the second outer coils are formed to have a corresponding winding diameter.

14. The actuator of claim 12, wherein a number of windings for at least one of the first and the second outer coils, and the inner coil is plural.

15. The actuator of claim 12, wherein:
the first molding part includes a first receiving hole to receive the coil elastic portion, and the second molding part includes a second receiving hole to receive the coil elastic portion, and
the first and the second receiving holes are connected to each other.

16. The actuator of claim 1, wherein a fixed curved portion is formed in at least one of one ends of the first and the second spring arms.

17. A spring comprising:
a coil elastic portion comprising a first outer coil, and an inner coil having a relatively smaller winding diameter than the first outer coil and of which one end is connected to an end of the first outer coil, and a second outer coil having a relatively larger winding diameter than the inner coil, and of which one end is connected to another end of the inner coil;
a first spring arm being extended from another end of the first outer coil; and
a second spring arm being extended from another end of the second outer coil,
wherein the first and the second outer coils are closely disposed, and the inner coil is disposed inside the first and the second outer coils.

18. The spring of claim 17, wherein the first and the second outer coils are formed to have a corresponding winding diameter.

19. The spring of claim 17, wherein a number of windings for at least one of the first and the second outer coils, and the inner coil is plural.

20. The spring of claim 17, wherein a fixed curved portion is formed in at least one of one ends of the first and the second spring arms.

21. An actuator comprising:
a first molding part;
a second molding part being rotatably connected in an end of the first molding part;
a third molding part being rotatably connected in an end of the second molding part;
a first torsion spring include a first spring arm fixed to each of the first and the second molding parts; and
a second torsion include a second spring arm fixed to each of the second and the third molding parts.

22. The actuator of claim 21, wherein facing spring arms among the first and the second spring arms are separable from each other.

23. The actuator of claim 21, wherein facing spring arms among the first and the second spring arms are integrally connected to each other.

24. The actuator of claim 23, wherein a slit is formed in the second molding part, and coil portions of the first and the second torsion springs are positioned in the opposite surface based on the second molding part, and the integrally connected spring arm of the first and the second torsion springs passes through the slit.

25. The actuator of claim 23, wherein the first and the second spring arms contacting with the first and the third molding parts in the first and the second torsion springs respectively make contact with the first and the third molding parts in the opposite direction to the integrally connected spring arm contacting with the second molding part.

26. The actuator of claim 21, wherein the first and the third molding parts rotate in the same region based on a long axis of the second molding part.

27. The actuator of claim 21, wherein the first and the third molding parts rotate in different regions based on a long axis of the second molding part.

28. The actuator of claim 21, wherein:
a first round portion is formed in at least one side of the first and the second molding parts, and a first guide surface for guiding rotation of the first round portion and a first combining protrusion for restraining separation of the first round portion are formed in another side of the first and the second molding parts, and
a second round portion is formed in at least one side of the second and the third molding parts, and a second guide surface for guiding rotation of the second round portion and a second combining protrusion for restraining separation of the second round portion are formed in another side f the second and the third molding parts.

29. The actuator of claim 21, wherein receiving grooves are formed in the first and the third molding parts to receive the first and the second spring arms respectively.

30. The actuator of claim 29, wherein an end of the receiving groove formed in each of the first and the third molding parts is curved in an L shape, and a free end of each of the first and the second spring arms is curved in the L shape in correspondence to the end of the curved receiving groove.

31. The actuator of claim 21, wherein each of the first and the third molding parts further comprises a pivot coupling portion that is pivot coupled with an object.

32. The actuator of claim 31, wherein the pivot coupling portion is formed together when the first and the third molding parts are formed by molding injection.

33. The actuator of claim 21, wherein the first and the second torsion springs comprise a coil elastic portion connecting spring arms that are extended to both sides, and
the coil elastic portion comprises:
a first outer coil being connected to any one of the extended spring arms;
an inner coil having a relatively smaller diameter than the first outer coil and of which one end is connected to the first outer coil; and
a second outer coil having a relatively larger diameter than the inner coil and of which one end is connected to another end of the inner coil and another end is connected to another spring arm of the extended spring arms.

34. The actuator of claim 33, wherein the first and the second outer coils are closely disposed, and the inner coil is disposed inside the first and the second outer coils.

35. The actuator of claim 33, wherein the first and the second outer coils are formed to have the same winding diameter.

36. The actuator of claim 33, wherein:
a first round portion is formed in at least one side of the first and the second molding parts, and a first rotation guide surface for guiding rotation of the first round portion is formed in another side thereof,
a second round portion is formed in at least one side of the second and the third molding parts, and a second rotation guide surface for guiding rotation of the second round portion is formed in another side thereof, and
a receiving hole is formed in each of the first and the second round portions to receive the coil elastic portion.

37. A spring comprising:
a first spring arm;
a second spring arm being connected to the first spring arm;
a third spring arm being connected to the second spring arm; and
a coil elastic portion being disposed at least one of between the first and the second spring arms and between the second and the third spring arms,
wherein the coil elastic portion comprises a first outer coil being connected to any one of the first and the third spring arms, an inner coil having a relatively smaller diameter than the first outer coil and of which one end is connected to the first outer coil, and a second outer coil having a relatively larger diameter than the inner coil and of which one end is connected to another end of the inner coil and of which another end is connected to the second spring arm.

38. The spring of claim 37, wherein the first and the second outer coils are closely disposed, and the inner coil is disposed inside the first and the second outer coils.

39. The spring of claim 37, wherein the first and the second outer coils are formed to have the same winding diameter.

40. An actuator of a slide-type mobile phone comprising a body that includes a keypad and a fixed frame and a cover that includes a sliding frame slidably coupled with the fixed frame to open and close the keypad and a display portion, the actuator comprising:
a first link plate being installed in the sliding frame to be rotatable using a first pivot pin by providing a first shaft to be parallel between the fixed frame and the sliding frame;
a second link plate being installed in the fixed frame to be rotatable using a second pivot pin by providing a second shaft to correspond to the first shaft;
a connecting plate including first and second guide holes punctured in both sides to slidably guide the first and the second shafts;
first and second compression coil springs being installed in the outer circumference of the first and the second shafts to close and open the keypad using the cover while the sliding frame is elastically sliding along the fixed frame by a certain external force; and
a flow preventing unit preventing flow of the first and the second link plates that slide in both sides of the connecting plate.

41. The actuator of claim 40, wherein:
the flow preventing unit includes a first guide rail in the first link plate along the axial direction of the first shaft, and forms a first flow preventing groove in the connecting plate to prevent flow when it is slidably coupled along the first guide rail, and
the flow preventing unit includes a second guide rail in the second link plate along the axial direction of the second shaft, and forms a second flow preventing groove in the connecting plate to prevent flow when it is slidably coupled along the second guide rail.

42. The actuator of claim 41, wherein:
a first rounded surface is formed in the first guide rail to contact with one surface of the first flow preventing groove, and a first line contact surface with a different circular arc is formed in the first flow preventing groove to make line contact with the first rounded surface of the first guide rail, and
a second rounded surface is formed in the second guide rail to contact with one surface of the second flow preventing groove, and a second line contact surface with a different circular arc is formed in the second flow preventing groove to make line contact with the second rounded surface of the second guide rail.

43. The actuator of claim 41, wherein:
a first operating hole is formed in both sides of the sliding direction of the first flow preventing groove, and a first stopper is formed in both sides of the first guide rail to slide along the first operating hole and restrain separation of the first link plate, and
a second operating hole is formed in both sides of the sliding direction of the second flow preventing groove, and a second stopper is formed in both sides of the second guide rail to slide along the second operating hole and restrain separation of the second link plate.

44. The actuator of claim 43, wherein:
a graded first gradient surface is formed in a front end of the first stopper and a tapered first guide surface is formed in an outer end of the first flow preventing groove to guide entrance of the first gradient surface, and
a graded second gradient surface is formed in a front end of the second stopper and a tapered second guide surface is formed in an outer end of the second flow preventing groove to guide entrance of the second gradient surface.
